(19) United States
(12) Patent Application Publication
(10) Pub. No.: US 2016/0370720 A1
(43) Pub. Date: Dec. 22, 2016

(54) TONER, DEVELOPER, IMAGE FORMING APPARATUS AND TONER HOUSING UNIT

(71) Applicants: Hiroshi Yamashita, Shizuoka (JP); Minoru Masuda, Shizuoka (JP); Hiroshi Yamada, Shizuoka (JP); Shizuka Hashida, Shizuoka (JP); Masanori Rimoto, Shizuoka (JP)

(72) Inventors: Hiroshi Yamashita, Shizuoka (JP); Minoru Masuda, Shizuoka (JP); Hiroshi Yamada, Shizuoka (JP); Shizuka Hashida, Shizuoka (JP); Masanori Rimoto, Shizuoka (JP)

(21) Appl. No.: 15/167,182

(22) Filed: May 27, 2016

(30) Foreign Application Priority Data
Jun. 22, 2015 (JP) 2015-124594
Nov. 11, 2015 (JP) 2015-221428

(51) Int. Cl. G03G 9/00

(52) U.S. Cl. CPC G03G 9/0821; G03G 15/08; G03G 9/08755

(57) ABSTRACT

A toner fixable on an image bearer with heat. The toner has a first storage modulus of from 1×10³ to 1×10⁶ Pa, measured at 100° C. when being heated, and a second storage modulus of from 1×10³ to 1×10⁶ Pa, measured at 100° C. when being cooled, the first storage modulus and second storage modulus being measured by a rheometer, and the second storage modulus at 100° C. when being cooled is higher than the first storage modulus at 100° C. when being heated.

### CROSS-REFERENCE TO RELATED APPLICATIONS

This patent application is based on and claims priority pursuant to 35 U.S.C. §119 to Japanese Patent Applications Nos. 2015-124594 and 2015-221428, filed on Jun. 22, 2015 and Nov. 11, 2015 respectively in the Japan Patent Office, the entire disclosure of which is hereby incorporated by reference herein.

### BACKGROUND

Technical Field

The present invention relates to a toner, a developer, an image forming apparatus and a toner housing unit.

Description of the Related Art

Various electrophotographic image forming apparatuses have been developed as image forming apparatuses such as copiers and printers.

The image forming process includes a process of forming an electrostatic latent image on the surface of a photoconductor drum as an image bearer, a process of developing the electrostatic latent image with a developer such as a toner to form a visible image, a process of transferring the developed image onto a recording paper with a transferer, and a process of fixing the toner image on the recording paper with a fixer using a pressure and a heat.

In the fixer, a fixing member and a pressure member formed of facing rollers, belts or their combinations contact each other to form a nip. A recording paper is inserted into the nip and applied with heat and pressure to fix the toner image on the recording paper.

To save energy required by the fixing process, which needs much electricity to heat and melt the toner, low-temperature fixability has been one of important properties for the toner.

The low-temperature fixability of the toner is also desired to achieve downsizing and quick start of the fixer. Therefore, a toner softenable at low temperature is used.

When a large amount of duplex prints having a large image area are accumulated on a paper discharge section, a discharged paper blocking phenomenon where the toner on a fixed image adheres to an upper discharged paper, i.e., discharged papers adhere each other through the fixed images, tends to occur. This phenomenon occurs because an image part of a printed paper overlaps another image part of another printed paper where the toner is not fully cooled and still softened after melted and fixed.

Since there is a trade-off relation between the low-temperature fixability of a toner and prevention of the discharged paper blocking, a technique to balance both of these is not found.

To prevent the discharged paper blocking, there is a method of blowing cooling air to the stacked discharged papers to cool them such that images do not adhere to image supports, papers and each other. However, this method needs an additional device which is not mountable on low-cost machines. Even when a toner having low-temperature fixability is used to save power consumption, the temperature of the stacked discharged papers is not decreased as the fixing temperature (energy) does, resulting in inability of preventing blocking.

There is a method of decreasing meltability of a toner with heat to decrease adhesiveness of images on the discharged paper. Therefore, a molecular weight of a resin forming the toner is increased, melting point or a glass transition temperature (Tg) of the resin is increased, and a crosslinked structure is imparted to the resin.

However, this method increases the fixing temperature and sacrifice energy saving. Images having high glossiness are difficult to produce, and are not suitable to high-definition or high color clearness image forming systems.

There is a method of increasing releasability of the surface of an image as well to prevent the discharged images from adhering to each other. This bleeds a wax as a release agent much on the surface of an image. However, it is necessary to use wax much and locate the wax at the surface of a toner to release therefrom to bleed much. This deteriorates fluidity and chargeability of the toner, and the wax needs to have a low melting point for the toner to have low-temperature fixability.

### SUMMARY

A toner fixable on an image bearer with heat. The toner has a first storage modulus of from 1×10³ to 1×10⁶ Pa, measured at 100° C. when being heated, and a second storage modulus of from 1×10³ to 1×10⁶ Pa, measured at 100° C. when being cooled, the first storage modulus and second storage modulus being measured by a rheometer, and the second storage modulus at 100° C. when being cooled is higher than the first storage modulus at 100° C. when being heated.

### BRIEF DESCRIPTION OF THE DRAWINGS

Various other objects, features and attendant advantages of the present invention will be more fully appreciated as the same becomes better understood from the detailed description when considered in connection with the accompanying drawings in which like reference characters designate like corresponding parts throughout and wherein:

FIG. 1 is a schematic view illustrating an embodiment of the image forming apparatus of the present invention;

FIG. 2 is a cross-sectional view illustrating a process cartridge which is an embodiment of the toner housing unit of the present invention;

FIG. 3 is a diagram showing a method of determining a peak half bandwidth of crystalline polyester by X-ray diffraction measurement.

### DETAILED DESCRIPTION

Accordingly, one object of the present invention is to provide a low-temperature fixable toner without causing a discharged paper blocking phenomenon where discharged papers adhere each other through images fixed thereon.

Another object of the present invention is to provide a developer including the above-described toner.

A further object of the present invention is to provide an image forming apparatus using the above-described toner.

Another object of the present invention is to provide a toner housing unit including the above-described toner.

In one embodiment, the above-described toner has a storage modulus of from 1×10³ to 1×10⁶ Pa at 100° C. when heated and cooled, and the storage modulus when cooled higher than when heated has low-temperature fixability and preventability of discharged paper blocking.

To control a toner to have a desired storage modulus at 100° C. when heated, a resin having a low Tg is selected for the toner and a molecular weight and a molecular weight distribution of the resin is controlled. Then, a crystalline resin or a plasticizer is preferably mixed to control the storage modulus more easily.

To control a toner to have a desired storage modulus at 100° C. when cooled, a quantity, a particle diameter, a dispersion status, etc. of a metal salt of a salicylic acid derivative added to a resin mentioned later are controlled.

The toner of the present invention changes in elasticity with a heat energy when fixed. For example, hydrogen bonding, covalent bonding, ionic bonding and coordinate bonding can be used to evoke an interaction between polymers of the resin. The ionic bonding is preferably used to evoke the interaction at low temperature.

As a result, a polymeric component is generated to increase a molecular weight of the toner after heated. To improve blocking resistance, the toner preferably has a rate of change of a weight-average molecular weight of from 10% to 140% to have good fixability and good adhesiveness to papers. More preferably from 30% to 80% to satisfy both of the fixability and blocking resistance.

Conventionally, such bonding increases elasticity of a toner when heated at high temperature to prevent hot offset. In the present invention, even when the toner is heated at a low temperature of 100° C., an interaction between polymers is generated to prevent blocking.

In the present invention, the ionic bonding or the coordinate bonding by heating a metal salt of a salicylic acid derivative and a polar group of the resin.

A resin having a carboxyl group is preferably used as the resin. Particularly, a polyester resin having a carboxyl group at its terminal is preferably used. The polyester resin preferably has an acid value of from 10 to 50 mg KOH/g, and more preferably from 20 to 40 mg KOH/g.

When plural resins are used, a low-molecular-weight resin and a low-Tg resin may be mixed to improve low-temperature fixability. Then, when the low-molecular-weight resin and the low-Tg resin have high acid values, a crosslinking reaction is preferentially performed therewith, and therefore the resultant low-temperature fixable toner has higher blocking resistance.

The polyester resin preferably has a hydroxyl value as well of from 5 to 40 mg KOH/g, and more preferably from 10 to 30 mg KOH/g to improve bondability between polymers.

The metal salt of a salicylic acid derivative preferably has the following formula (1):

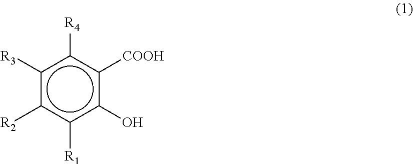

wherein R¹, R², R³ and R⁴ independently represent a member selected from the group consisting of a hydrogen atom, an alkyl group having 1 to 12 carbon atoms, an alkenyl group having 1 to 12 carbon atoms, —OH, —NH₂, —NH(CH₃), —N(CH₃)₂, —OCH₃, —O(C₂H₅), —COOH and —CONH₂.

A metal forming the metal salt is Zn²⁺, Al³⁺, Cr³⁺, Fe³⁺ or Zr⁴⁺.

Among the metal salts of a salicylic acid derivative having the formula (1), a tri- or more valent metals efficiently performing interactions are preferably used.

Particularly, a zirconium compound having the following formula (2) is preferably used:

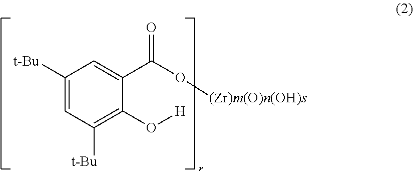

wherein m represents an integer of from 1 to 20; n represents 0 or an integer of from 1 to 20; s represents 0 or an integer of from 1 to 20; r represents an integer of from 1 to 20; and t-Bu represents a tertiary butyl group.

The toner of the present invention increases in its molecular weight when heated. Polymeric components therein increase at 100° C. and a weight-average molecular weight thereof increases. The maximum molecular weight does not vary much. Therefore, a part of the polymeric components is thought crosslinked.

A rate of change Rₘ (%) determined from the following formula (3) is preferably from 10% to 140%, and more preferably from 30% to 80%:

R_{M}=(Mw2−Mw1)/Mw1×100 (3)

wherein Mw1 represents a weight-average molecular weight of the toner before heated; and Mw2 represents a weight-average molecular weight thereof after heated.

As the reaction proceeds, the toner decreases in its acid value. A rate of the decrease is thought to depend on an acid value of the toner and existence of the metal salt of a salicylic acid derivative. A rate of change R_{AV} (%) determined from the following formula (4) is preferably from 20% to 80%:

R_{AV}=(Av2−Av1)/Av1×100 (4)

wherein Av1 represents an acid value of the toner before heated; and Av2 represents an acid value of thereof after heated.

The acidic group preferably has a larger rate of change of the acid value in terms of preventing blocking because of reacting with the metal salt of a salicylic acid to decrease the storage modulus of a resin. Meanwhile, the rate of change of the acid value of the acidic group may not be too large in terms of fixability (adhesiveness to a paper) because the acidic groups improves fixability. Therefore, the rate of change of the acid value s preferably from 20% to 80% to improve fixability and blocking resistance of the resultant toner.

Conventionally, the metal salt of a salicylic acid derivative is added to a resin as a charge controlling agent. For example, the metal salt of a salicylic acid derivative is added to a resin, and the mixture is melted, kneaded and pulverized to prepare a pulverization toner. However, since the resultant pulverization toner is heated after the processes of melting, kneading and pulverizing, the elasticity of the toner after heated is not larger than that thereof before heated.

The conventional metal salt of a salicylic acid derivative added to a resin as a charge controlling agent may be present at the surface of a toner and need not be dispersed therein.

In the present invention, the metal salt of a salicylic acid derivative may not react in a toner before heated and needs to react with a resin when heated.

Therefore, it is important not to provide a heating process at high temperature such that the metal salt of a salicylic acid derivative may not react in the processes of producing a toner. The processes of producing a toner preferably do not include a heating process at a temperature not lower than a Tg+20° C. of the toner. When the processes of producing a toner includes a heating process at a temperature not lower than the Tg+20° C., a resin in the toner is promoted to crosslink to increase elasticity and deteriorate low-temperature fixability of the resultant toner

It is important that the metal salt of a salicylic acid derivative is molecularly dissolved, or dispersed in the shape of a fine particle or a crystal in a toner to effectively react with a resin when heated at low temperature. Therefore, a salt needs to be formed in a toner in the process of producing the toner or a fine dispersion process needs to be provided.

The toner preferably has a storage modulus G′ of from 1×10³ to 1×10⁶ Pa at 100° C. when heated, and more preferably from 1×10⁴ to 1×10⁵ Pa at 100° C. when heated to have low-temperature fixability. When the storage modulus G′ is not greater than 1×10⁶ Pa, the toner has good thermoplasticizability and is fixable at low temperature. When less than 1×10³ Pa when heated, the toner is difficult to have preservability.

It is more preferable that the toner has a storage modulus G′ of from 1×10³ to 1×10⁶ Pa at 100° C. when cooled, and that the storage modulus at 100° C. when cooled is higher than the storage modulus at 100° C. when heated. Under these conditions, images on papers are sufficiently hard and not fusion-bonded with each other when discharged to prevent discharged papers from blocking. When the storage modulus G′ is greater than 1×10⁶ Pa, the toner has high elasticity, resulting in insufficient glossiness of images.

When the storage modulus when cooled is higher than the storage modulus when heated, the resultant image has good preservability. Not only when a paper is discharged, when images are stored at high temperature and high humidity, an image and a paper, or images adhere to each other, i.e., a document offset phenomenon occurs. However, under this condition, images after fixed is crosslinked and increases in strength not to be influenced by heat and moisture.

A chemical toner production method is suitably used to finely present a salicylic acid derivative compound in a toner. Specific examples thereof include the followings.

1) A process of finely dispersing the salicylic acid derivative compound mechanically in an oil phase is provided in suspension polymerization methods and dissolution suspension methods.

2) In the suspension polymerization methods and dissolution suspension methods, there is a method of synthesizing the salicylic acid derivative compound in an oil phase as a method of producing fine crystals and particles in an oil phase (a polymerizable monomer or a resin solvent solution). For example, an aqueous solution of 1,3-di-t-butyl salicylic acid and an aqueous solution of zirconium oxychloride are placed in an oil phase and reacted therein to produce a fine zirconium compound in toner materials. Water or a polar solvent such as alcohol and ether may be present in the oil phase to proceed the reaction.

3) A process of finely dispersing the salicylic acid derivative compound mechanically in an aqueous phase is provided in emulsion aggregation methods. Then, the salicylic acid derivative compound is aggregated or particulated with other toner materials such as resin latex to form a toner.

4) In the emulsion aggregation methods, there is a method of synthesizing the salicylic acid derivative compound in an aqueous phase as a method of producing fine crystals and particles in an aqueous phase. For example, an aqueous solution of 1,3-di-t-butyl salicylic acid and an aqueous solution of zirconium oxychloride are placed in an aqueous phase and reacted therein to precipitate and produce a fine zirconium compound in the aqueous phase. Then, the salicylic acid derivative compound is aggregated or particulated with other toner materials such as resin latex to form a toner. The fine particles are preferably fusion-bonded at as a low temperature as possible such that a crosslinking reaction is not performed in the toner. For example, a resin emulsion using an organic solvent is effectively used as a binder resin material.

In the present invention, the salicylic acid derivative compound is thought to have a crosslinking structure with a polyester resin in a toner when heated to increase storage modulus of the toner. The toner is preferably produced at not higher than Tg+20° C. (of the resin), and more preferably not higher than Tg to include the zirconium compound. When not less than Tg+20° C., the salicylic acid derivative compound further crosslinks with the toner and the toner increases in storage modulus when heated, and may deteriorate in low-temperature fixability.

The toner preferably includes the salicylic acid derivative compound in an amount of from 0.01% to 10% by mass, and more preferably from 0.1% to 2% by mass to increase storage modulus when cooled and not to impair low-temperature fixability with a zirconium compound included therein.

A crystalline polyester resin and a polyester resin having a low glass transition temperature are effectively used in the toner of the present invention.

### <Measurement of Storage Modulus G′>

The storage modulus (G′ 100) at 100° C. when heated and cooled is measured by a rotational plate rheometer “ARES” from TA Instruments Japan Inc. A sample is formed into a pellet having a diameter of 8.0±0.3 mm, and a thickness of 1.0±0.3 mm, and the pellet sample is fixed to a parallel plate having a diameter of 8.0 mm, followed by stabilizing at 40° C. Then, the sample is heated to 120° C. at 2.0° C./min with frequency of 10 Hz (6.28 rad/s), and strain of 0.1% (in a strain control mode), and then cooled to 40° C. at 2.0° C./min.

It is important to set a sample such that the initial normal force is 0. As mentioned below, Auto Tension Adjustment is on since then to cancel the influence of normal force.

The apparatus is set as follows in detail when the storage modulus G′ is measured.

(1) A parallel plate having a diameter of 8.0 mm is used.

(2) Frequency is 10 Hz (6.28 rad/s).

(3) Initial strain is 0.1%.

(4) Ramp rate is 2.0° C./min from 40° C. to 200° C. The following auto control mode including auto strain control mode is used.

(5) Max applied strain is 200%.

(6) Max allowed torque is 500 g·cm and min allowed torque is 500 g·cm.

(7) Strain adjustment is 15% of current strain. Auto tension is used.

(8) Auto tension direction is compression.

(9) Initial static force is 10.0 g and auto tension sensitivity is 300 g.

(10) Operation conditions of auto tension is includes sample modulus not less than 10 (Pa).

The storage modulus G′ at 100° C. when heated is G′↑100 in measuring the storage modulus G′ at from 40° C. to 120° C. by the above method.

The storage modulus G′ at 100° C. when cooled is G′↓100 in measuring the storage modulus G′ at from 120° C. to 40° C. by the above method.

### <Amorphous Polyester Resin>

Details of constituents of an amorphous polyester resin are as follows.

### --Diol---

Diols are not particularly limited if they include aliphatic diols in an amount not less than 50% by mol, and specific examples thereof include aliphatic diols such as ethylene glycol, 1,2-propylene glycol, 1,3-propylene glycol, 1,4-butanediol, and 1,6-hexanediol, 1,8-octanediol, 1,10-decanediol and 1,12-dodecanediol; diols having an oxy alkylene group such as diethylene glycol, triethylene glycol, dipropylene glycol, polyethylene glycol, polypropylene glycol and polytetramethylene; alicyclic diol such as 1,4-cyclohexanedimethanol and hydrogenated bisphenol A; adducts of the above-mentioned alicyclic diol with an alkylene oxide such as ethylene oxide, propylene oxide and butylene oxide; bisphenols such as bisphenol A, bisphenol F and bisphenol S; and adducts of the above-mentioned bisphenol with an alkylene oxide such as ethylene oxide, propylene oxide and butylene oxide. In particular, aliphatic diols having 4 to 12 carbon atoms are preferably used. These diols can be used alone or in combination.

### ---Dicarboxylic Acid---

Specific examples of the dicarboxylic acid include, but are not limited to, aliphatic dicarboxylic acids and aromatic dicarboxylic acids. Their anhydrides, lower (having 1 to 3 carbon atoms) alkyl esterified compounds and halogenated compounds may be used.

Specific examples of the aliphatic dicarboxylic acid include, but are not limited to, succinic acid, adipic acid, sebacic acid, dodecanedioic acid, maleic acid and fumaric acid.

Specific examples of the aromatic dicarboxylic acid include, but are not limited to, phthalic acid, isophthalic acid, terephthalic acid, naphthalene dicarboxylic acid. Among these, aliphatic dicarboxylic acids having 4 to 12 carbon atoms are preferably used.

These dicarboxylic acids may be used alone or in combination.

### --Tri- or Higher Valent Alcohol---

Specific examples of tri- or higher valent aliphatic alcohol include, but are not limited to, glycerin, trimethylolethane, trimethylolpropane, pentaerythritol, sorbitol and dipentaerythritol. Among these, tri- to tetravalent aliphatic alcohols are preferably used. These tri- or higher valent aliphatic alcohols can be used alone or in combination.

The amorphous polyester resin preferably has an acid value not less than 10 mg KOH/g, and more preferably not less than 20 mg KOH/g for the resultant toner to have desired low-temperature fixability in terms of affinity between papers and resins. Meanwhile, the amorphous polyester resin preferably has an acid value not greater than 50 mg KOH/g for the resultant toner to improve hot offset resistance.

The crystalline polyester resin preferably has a hydroxyl value of from 5 to 40 mg KOH/g, and more preferably from 10 to 30 mg KOH/g for the resultant toner to have desired low-temperature fixability and good blocking resistance.

In the present invention, the acid value of the binder resin component can is measured according to JIS K-0070 as follows.

(1) 0.5 to 2.0 g of the toner is precisely weighed and the weight of the polymer is W g.

(2) The toner are dissolved with 150 ml of a mixture of toluene/ethanol (volume ratio 4/1) to prepare a solution in a beaker having a capacity of 300 ml.

(3) The solution is titrated with a potentiometric titrator using an ethanol solution 0.1 mol/l KOH.

(4) The usage of the ethanol solution is S (ml), and at the same time, the usage thereof without the sample is B (ml) and the acid value is determined by the following formula (C):

Acid value (mg KOH/g)=[(S−B)×f×5.61]/W (C)

wherein f is a factor of KOH.

A polyester resin including a urethane bond and a urea bond is used to control viscoelasticity with hydrogen bonding strength.

### --Polyester Resin Having Urethane Bond and Urea Bond-

Specific examples of the polyester resin including a urethane bond and a urea bond include, but are not limited to, reaction products between a polyester resin having an active hydrogen group and polyisocyanate.

### ---Polyisocyanate---

Specific examples of the polyisocyanate include, but are not limited to, diisocyanate and tri- or higher valent isocyanate.

Specific examples of the diisocyanate include, but are not limited to, aliphatic diisocyanate; alicyclic diisocyanate; aromatic diisocyanate; aromatic aliphatic diisocyanate; isocyanurate; and a block product thereof where the foregoing compounds are blocked with a phenol derivative, oxime, or caprolactam.

Specific examples of the aliphatic diisocyanate include, but are not limited to, tetramethylene diisocyanate, hexamethylene diisocyanate, 2,6-diisocyanato methyl caproate, octamethylene diisocyanate, decamethylene diisocyanate, dodecamethylene diisocyanate, tetra decamethylene diisocyanate, trimethyl hexane diisocyanate, tetramethyl hexane and diisocyanate.

Specific examples of the alicyclic diisocyanate include, but are not limited to, isophorone diisocyanate and cyclohexylmethane diisocyanate.

Specific examples of the aromatic diisocyanate include, but are not limited to, tolylene diisocyanate, diisocyanato diphenyl methane, 1,5-naphthalene diisocyanate, 4,4′-diisocyanato diphenyl, 4,4′-diisocyanato-3, 3′-dimethyldiphenyl, 4,4′-diisocyanato-3-methyldiphenyl methane and 4,4′-diisocyanato-diphenyl ether.

Specific examples of the aromatic aliphatic diisocyanate include, but are not limited to, α,α,α′,α′-tetramethylxylene diisocyanate.

Specific examples of the isocyanurate include, but are not limited to, tris(isocyanatoalkyl)isocyanurate and tris(isocyanatocycloalkyl)isocyanurate. These polyisocyanates may be used alone or in combination, and are preferably used as precursors before reaction (prepolymer) reacting with a curing agent mentioned later.

### -Curing Agent-

The curing agent is not particularly limited and may be appropriately selected depending on the intended purpose, so long as it can react with the prepolymer. Examples thereof include an active hydrogen group-containing compound.

### --Active Hydrogen Group-Containing Compound-

An active hydrogen group in the active hydrogen group-containing compound is not particularly limited and may be appropriately selected depending on the intended purpose. Examples thereof include a hydroxyl group (e.g., an alcoholic hydroxyl group, and a phenolic hydroxyl group), an amino group, a carboxyl group, and a mercapto group. These may be used alone or in combination.

The active hydrogen group-containing compound is preferably amines, because it can form a urea bond.

Specific examples of the amines include, but are not limited to, diamine, trivalent or higher amine, amino alcohol, amino mercaptan, amino acid and compounds in which the amino groups of the foregoing compounds are blocked. These may be used alone or in combination

Among them, diamine, and a mixture of diamine and a small amount of tri- or higher valent amine are preferably used.

Specific examples of the diamine include, but are not limited to, aromatic diamine, alicyclic diamine and aliphatic diamine.

Specific examples of the aromatic diamine include, but are not limited to, phenylenediamine, diethyl toluene diamine and 4,4′-diaminodiphenylmethane.

Specific examples of the alicyclic diamine include, but are not limited to, 4,4′-diamino-3, 3′-dimethyldicyclohexyl methane, diamino cyclohexane and isophoronediamine.

Specific examples of the aliphatic diamine include, but are not limited to, ethylene diamine, tetramethylene diamine and hexamethylenediamine.

Specific examples of the tri- or higher valent amine include, but are not limited to, diethylenetriamine and triethylene tetramine.

Specific examples of the amino alcohol include, but are not limited to, ethanol amine and hydroxyethyl aniline.

Specific examples of the amino mercaptan include, but are not limited to, aminoethyl mercaptan and aminopropyl mercaptan.

Specific examples of the amino acid include, but are not limited to, amino propionic acid and amino caproic acid.

Specific examples of the compound where the amino group is blocked include, but are not limited to, a ketimine compound where the amino group is blocked with ketone such as acetone, methyl ethyl ketone, methyl isobutyl ketone and an oxazoline compound.

A molecular structure of the amorphous polyester resin can be measured by solution-state or solid-state NMR, X-ray diffraction, GC/MS, LC/MS, or IR spectroscopy. Simple methods for confirming the molecular structure thereof include a method for detecting, as the polyester resin, one that does not have absorption based on δCH (out-of-plane bending vibration) of olefin at 965 cm⁻¹±10 cm⁻¹ and 990 cm⁻¹±10 cm⁻¹ in an infrared absorption spectrum.

The content of the amorphous polyester resin used as a prepolymer is not particularly limited and may be appropriately selected depending on the intended purpose, but preferably from 5 parts to 25 parts by mass, and more preferably from 10 to 20 parts by mass per 100 parts by mass of the toner. When less than 5 parts by mass, the toner may deteriorate in low-temperature fixability and hot offset resistance. When greater than 25 parts by mass, heat resistant preservability of the toner and glossiness of images after fixed may deteriorate. When the content is from 10 to 20 parts by mass, the toner advantageously has good low-temperature fixability, hot offset resistance and heat resistant preservability.

### <Crystalline Polyester Resin>

Having crystallinity, the crystalline polyester resin has heat meltability quickly having low viscosity around a fixation starting temperature, and may be used with the amorphous polyester resin. When the crystalline polyester resin having such properties is used together with the amorphous polyester resin, the toner has good heat resistant preservability due to crytallinity just before a melt starting temperature. At the melt starting temperature, the toner quickly decreases in viscosity due to melting of the crystalline polyester resin. Then, the crystalline polyester resin is compatible with an amorphous polyester resin, and they quickly decrease in viscosity together to obtain a toner having good heat resistant preservability and low-temperature fixability. In addition, a release width (a difference between a fixable minimum temperature and a temperature at which hot offset occurs) has a good result.

The crystalline polyester resin is obtained by polymerizing polyols; and polycarboxylic acids such as polycarboxylic acids, polycarboxylic acid anhydrides and polycarboxylic acid esters or their derivatives.

In the present invention, modified polyester resins such as the prepolymer and resins obtained by crosslinking and/or elongating the prepolymer do not belong to the crystalline polyester resin.

The crystalline polyester resin preferably has a half-value width less than 1.0°/2θ in its X-ray diffraction, and more preferably less than 0.6°/2θ. When not less than 1.0°/2θ, the crystalline polyester resin has low crystallinity and poor sharp meltability, resulting in insufficient low-temperature fixability of the resultant toner.

The crystalline polyester resin preferably has a half-value width less than 1.0° in its X-ray diffraction, and more preferably less than 0.6° after dissolved in an organic solvent and recrystallized. When not less than 1.0°, the crystalline polyester resin has low crystallinity and I partially compatible with the amorphous polyester, resulting in deterioration of low-temperature fixability and heat resistant preservability of the resultant toner. In addition, filming of the crystalline polyester resin tends to occur, resulting in contamination of the image developer and deterioration of image quality.

X-ray diffraction measurement of the crystalline polyester can be measured by a crystal analysis X-ray diffractometer X'Pert Pro MRD from Philips N.V. as follows. First, a sample is ground in a mortar to prepare a powder thereof. The sample powder is uniformly applied on a sample holder. The sample holder is set in the diffractometer to obtain a diffraction spectrum.

Diffraction peaks obtained within a range of the diffraction peaks 20°<2θ<25° are defined as P1, P2 . . . in order of peak intensity.

A peak half-value width (FWHM) is defined as a difference between points x1 and x2 which are half of maximum peak intensity.

Conditions of the X-ray diffraction analysis are as follows.

Tension kV: 45 kV

Current: 40 A

MPSS

Gonio

Scanmode: continuous

Start angle: 3°

End angle: 35°

Angle Step: 0.02°

Lucident beam optics

Divergence slit: Div slit 1/2

Difflection beam optics

Anti scatter slit: As Fixed 1/2

Receiving slit: Prog rec slit

### (Method of Dissolving Crystalline Polyester in Organic Solvent and Recrystallizing Crystalline Polyester)

A method of dissolving the crystalline polyester in an organic solvent and recrystallizing the crystalline polyester is as follows.

Ten (10) g of the crystalline polyester and 90 g of an organic solvent are stirred at 70° C. for 1 hr.

After stirred, the solution is cooled at 20° C. for 12 hrs to recrystallize the crystalline polyester.

The organic solvent dispersion after the crystalline polyester is recrystallized is filtered under reduced pressure by an aspirator with a Kiriyama funnel and Kiriyama filter No. 4 from Kiriyma Glass Works Co. to separate the crystalline polyester from the organic solvent.

The separated crystalline polyester is dried at 35° C. for 48 hrs to obtain the recrystallized crystalline polyester.

Details of constituents of the crystalline polyester resin are as follows.

### -Polyol-

The polyol is not particularly limited and may be appropriately selected depending on the intended purpose. Examples thereof include diol, and tri- or higher valent alcohol.

Specific examples of the diol include saturated aliphatic diol, etc. Specific examples of the saturated aliphatic diol include straight chain saturated aliphatic diol, and branched-chain saturated aliphatic diol. Among them, straight chain saturated aliphatic diol is preferably used, and straight chain saturated aliphatic diol having 2 to 12 carbon atoms is more preferably used. When the saturated aliphatic diol has a branched-chain structure, crystallinity of the crystalline polyester resin may be low, and thus may lower the melting point. When the number of carbon atoms in the saturated aliphatic diol is greater than 12, it may be difficult to yield a material in practice. The number of carbon atoms is preferably not greater than 12.

Specific examples of the saturated aliphatic diol include ethylene glycol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,18-octadecanediol, 1,14-eicosanedecanediol, etc. Among them, ethylene glycol, 1,4-butanediol, 1,6-hexanediol, 1,8-octanediol, 1,10-decanediol, and 1,12-dodecanediol are preferably used, as they give high crystallinity to a resulting crystalline polyester resin, and give excellent sharp melt properties. Specific examples of the tri- or higher valent alcohol include glycerin, trimethylol ethane, trimethylolpropane, pentaerythritol, etc. These may be used alone or in combination.

### -Polycarboxylic Acid-

The multivalent carboxylic acid is not particularly limited and may be appropriately selected depending on the intended purpose. Examples thereof include divalent carboxylic acid, and tri- or higher valent carboxylic acid.

Specific examples of the divalent carboxylic acid include saturated aliphatic dicarboxylic acids such as an oxalic acid, a succinic acid, a glutaric acid, an adipic acid, a suberic acid, an azelaic acid, a sebacic acid, a 1,9-nonanedicarboxylic acid, a 1,10-decanedicarboxylic acid, a 1,12-dodecanedicarboxylic acid, a 1,14-tetradecanedicarboxylic acid, and a 1,18-octadecanedicarboxylic acid; aromatic dicarboxylic acids of dibasic acid such as a phthalic acid, an isophthalic acid, a terephthalic acid, a naphthalene-2,6-dicarboxylic acid, a malonic acid, a and mesaconic acid; and anhydrides of the foregoing compounds, and lower (having 1 to 3 carbon atoms) alkyl ester of the foregoing compounds, etc.

Specific examples of the tri- or higher valent carboxylic acid include 1,2,4-benzenetricarboxylic acid, 1,2,5-benzenetricarboxylic acid, 1,2,4-naphthalene tricarboxylic acid, anhydrides thereof, and lower (having 1 to 3 carbon atoms) alkyl esters thereof, etc.

Moreover, the polycarboxylic acid may contain, other than the saturated aliphatic dicarboxylic acid or aromatic dicarboxylic acid, dicarboxylic acid containing a sulfonic acid group. Further, the polycarboxylic acid may contain, other than the saturated aliphatic dicarboxylic acid or aromatic dicarboxylic acid, dicarboxylic acid having a double bond. These may be used alone or in combination.

The crystalline polyester resin is preferably composed of a straight chain saturated aliphatic dicarboxylic acid having 4 to 12 carbon atoms and a straight chain saturated aliphatic diol having 2 to 12 carbon atoms. Namely, the crystalline polyester resin preferably includes a structural unit coming from a saturated aliphatic dicarboxylic acid having 4 to 12 carbon atoms and a structural unit coming from a saturated aliphatic diol having 2 to 12 carbon atoms. As a result of this, the crystalline polyester resin has high crystallinity and good sharp meltability, and the resultant toner has good low-temperature fixability.

A melting point of the crystalline polyester resin is not particularly limited and may be appropriately selected depending on the intended purpose, but it is preferably 60° C. to 80° C. When the melting point thereof is less than 60° C., the crystalline polyester resin tends to melt at low temperature, which may impair heat resistant preservability of the toner. When the melting point thereof is greater than 80° C., melting of the crystalline polyester resin with heat applied during fixing may be insufficient, which may impair low-temperature fixability of the toner.

A molecular weight of the crystalline polyester resin is not particularly limited and may be appropriately selected depending on the intended purpose. Since those having a sharp molecular weight distribution and low molecular weight have excellent low-temperature fixability, and heat resistant preservability of the resultant toner lowers as an amount of a low molecular weight component, an o-dichlorobenzene soluble component of the crystalline polyester resin preferably has the weight average molecular weight (Mw) of 3,000 to 30,000, number average molecular weight (Mn) of 1,000 to 10,000, and Mw/Mn of 1.0 to 10, as measured by GPC. Further, it is more preferred that the weight average molecular weight (Mw) thereof be 5,000 to 15,000, the number average molecular weight (Mn) thereof be 2,000 to 10,000, and the Mw/Mn be 1.0 to 5.0.

An acid value of the crystalline polyester resin is not particularly limited and may be appropriately selected depending on the intended purpose, but it is preferably not less than 5 mg KOH/g, more preferably not less than 10 mg KOH/g for achieving the desired low-temperature fixability in view of affinity between paper and the resin. Meanwhile, the acid value thereof is preferably 45 mg KOH/g or lower for the purpose of improving hot offset resistance.

A hydroxyl value of the crystalline polyester resin is not particularly limited and may be appropriately selected depending on the intended purpose. However, it is preferably 0 mg KOH/g to 50 mg KOH/g, more preferably 5 mg KOH/g to 50 mg KOH/g, in order to achieve the desired low-temperature fixability and excellent charging property.

A molecular structure of the crystalline polyester resin can be measured by solution-state or solid-state NMR, X-ray diffraction, GC/MS, LC/MS, or IR spectroscopy. Simple methods for confirming the molecular structure thereof include a method for detecting, as a crystalline polyester resin, one that has absorption based on δCH (out-of-plane bending vibration) of olefin at 965 cm⁻¹±10 cm⁻¹ and 990 cm⁻¹±10 cm⁻¹ in an infrared absorption spectrum.

The content of the crystalline polyester resin is not particularly limited and may be appropriately selected depending on the intended purpose, but it is preferably 3 to 20 parts by mass, more preferably 5 to 15 parts by mass, relative to 100 mass by mass of the toner. When the amount thereof is less than 3 parts by mass, the crystalline polyester resin is insufficient in sharp melt property, and thus the resultant may be deteriorated in heat resistant preservability. When it is greater than 20 parts by mass, the resultant toner may be deteriorated in heat resistant preservability, and fogging of an image may be caused. When the amount thereof is within more preferable range than the aforementioned range, it is advantageous that the resultant toner is excellent in both high image quality and low-temperature fixability.

### <Other Toner Constituents>

Examples of other toner constituents include a release agent, a colorant, a charge controlling agent, an external additive, a fluidity improver, a cleanability improver, and a magnetic material.

Specific examples of wax serving as the release agent include natural wax such as vegetable wax (e.g., carnauba wax, cotton wax, Japan wax and rice wax), animal wax (e.g., bees wax and lanolin), mineral wax (e.g., ozokelite and ceresine) and petroleum wax (e.g., paraffin wax, microcrystalline wax and petrolatum).

Specific examples of the wax other than the above natural wax include a synthetic hydrocarbon wax (e.g., Fischer-Tropsch wax and polyethylene wax; and a synthetic wax (e.g., ester wax, ketone wax and ether wax).

Further, other examples of the release agent include fatty acid amides such as 12-hydroxystearic acid amide, stearic amide, phthalic anhydride imide and chlorinated hydrocarbons; low-molecular-weight crystalline polymers such as acrylic homopolymers (e.g., poly-n-stearyl methacrylate and poly-n-lauryl methacrylate) and acrylic copolymers (e.g., n-stearyl acrylate-ethyl methacrylate copolymers); and crystalline polymers having a long alkyl group as a side chain.

Among them, a hydrocarbon wax such as a paraffin wax, a microcrystalline wax, a Fischer-Tropsch wax, a polyethylene wax, and a polypropylene wax is preferably used. A melting point of the release agent is not particularly limited and may be appropriately selected depending on the intended purpose, but it is preferably 60° C. to 80° C. When the melting point thereof is less than 60° C., the release agent tends to melt at low temperature, which may impair heat resistant preservability. When the melting point thereof is greater than 80° C., the release agent does not sufficiently melt to thereby cause fixing offset, even in the case where the resin is in the fixing temperature range, which may cause defects in an image.

The content of the release agent is appropriately selected depending on the intended purpose without any limitation, but it is preferably 2 to 10 parts by mass, more preferably 3 to 8 parts by mass, relative to 100 parts by mass of the toner. When the amount thereof is less than 2 parts by mass, the resultant toner may have insufficient hot offset resistance, and low-temperature fixability during fixing. When the amount thereof is greater than 10 parts by mass, the resultant toner may have insufficient heat resistant preservability, and tends to cause fogging in an image. When the content thereof is within the aforementioned more preferable range, it is advantageous because image quality and fixing stability can be improved.

### -Colorant-

The colorant is appropriately selected depending on the intended purpose without any limitation, and examples thereof include carbon black, a nigrosin dye, iron black, naphthol yellow S, Hansa yellow (10G 5G and G), cadmium yellow, yellow iron oxide, yellow ocher, yellow lead, titanium yellow, polyazo yellow, oil yellow, Hansa yellow (GR, A, RN and R), pigment yellow L, benzidine yellow (G and GR), permanent yellow (NCG), vulcan fast yellow (5G, R), tartrazine lake, quinoline yellow lake, anthrasan yellow BGL, isoindolinon yellow, colcothar, red lead, lead vermilion, cadmium red, cadmium mercury red, antimony vermilion, permanent red 4R, parared, fiser red, parachloroorthonitro aniline red, lithol fast scarlet G, brilliant fast scarlet, brilliant carmine BS, permanent red (F2R, F4R, FRL, FRLL and F4RH), fast scarlet VD, vulcan fast rubin B, brilliant scarlet G, lithol rubin GX, permanent red FSR, brilliant carmine 6B, pigment scarlet 3B, Bordeaux 5B, toluidine Maroon, permanent Bordeaux F2K, Helio Bordeaux BL, Bordeaux 10B, BON maroon light, BON maroon medium, eosin lake, rhodamine lake B, rhodamine lake Y, alizarin lake, thioindigo red B, thioindigo maroon, oil red, quinacridone red, pyrazolone red, polyazo red, chrome vermilion, benzidine orange, perinone orange, oil orange, cobalt blue, cerulean blue, alkali blue lake, peacock blue lake, Victoria blue lake, metal-free phthalocyanine blue, phthalocyanine blue, fast sky blue, indanthrene blue (RS and BC), indigo, ultramarine, iron blue, anthraquinone blue, fast violet B, methyl violet lake, cobalt purple, manganese violet, dioxane violet, anthraquinone violet, chrome green, zinc green, chromium oxide, viridian, emerald green, pigment green B, naphthol green B, green gold, acid green lake, malachite green lake, phthalocyanine green, anthraquinone green, titanium oxide, zinc flower, and lithopone.

The content of the colorant is not particularly limited and may be appropriately selected depending on the intended purpose, but it is preferably 1 to 15 parts by mass, more preferably 3 to 10 parts by mass, relative to 100 parts by mass of the toner.

The colorant may be used as a master batch in which the colorant forms a composite with a resin. As a resin used in the production of the master batch or a resin kneaded together with the master batch, other than the another polyester resin, polymer of styrene or substitution thereof (e.g., polystyrene, poly-p-chlorostyrene, and polyvinyl toluene); styrene copolymer (e.g., styrene-p-chlorostyrene copolymer, styrene-propylene copolymer, styrene-vinyl toluene copolymer, styrene-vinyl naphthalene copolymer, styrene-methyl acrylate copolymer, styrene-ethyl acrylate copolymer, styrene-butyl acrylate copolymer, styrene-octyl acrylate copolymer, styrene-methyl methacrylate copolymer, styrene-ethyl methacrylate copolymer, styrene-butyl methacrylate copolymer, styrene-methyl α-chloromethacrylate copolymer, styrene-acrylonitrile copolymer, styrene-methyl vinyl ketone copolymer, styrene-butadiene copolymer, styrene-isoprene copolymer, styrene-acrylonitrile-indene copolymer, styrene-maleic acid copolymer, and styrene-maleic acid ester copolymer); and others including polymethyl methacrylate, polybutyl methacrylate, polyvinyl chloride, polyvinyl acetate, polyethylene, polypropylene, polyester, epoxy resin, epoxy polyol resin, polyurethane, polyamide, polyvinyl butyral, polyacrylic acid resin, rosin, modified rosin, a terpene resin, an aliphatic or alicyclic hydrocarbon resin, an aromatic petroleum resin, chlorinated paraffin, and paraffin wax can be used. These may be used alone or in combination.

The master batch can be prepared by mixing and kneading the colorant with the resin for the master batch. In the mixing and kneading, an organic solvent may be used for improving the interactions between the colorant and the resin. Moreover, the master batch can be prepared by a flashing method in which an aqueous paste containing a colorant is mixed and kneaded with a resin and an organic solvent, and then the colorant is transferred to the resin to remove the water and the organic solvent. This method is preferably used because a wet cake of the colorant is used as it is, and it is not necessary to dry the wet cake of the colorant to prepare a colorant. In the mixing and kneading of the colorant and the resin, a high-shearing disperser (e.g., a three-roll mill) is preferably used.

### -Charge Controlling Agent-

The charge controlling agent is not particularly limited and may be appropriately selected depending on the intended purpose. Examples thereof include a nigrosine-based dye, a triphenylmethane-based dye, a chromium-containing metallic complex dye, a molybdic acid chelate pigment, a rhodamine-based dry, alkoxy-based amine, a quaternary ammonium salt (including a fluorine-modified quaternary ammonium salt), alkylamide, a simple substance or a compound of phosphorus, a simple substance or a compound of tungsten, a fluorine-based activator, a salicylic acid metallic salt, a metallic salt of salicylic acid derivative, etc. Specific examples thereof include a nigrosine dye BONTRON 03, a quaternary ammonium salt BONTRON P-51, a metal-containing azo dye BONTRON S-34, an oxynaphthoic acid-based metal complex E-82, a salicylic acid-based metal complex E-84 and a phenol condensate E-89 (all products of ORIENT CHEMICAL INDUSTRIES CO., LTD.); quaternary ammonium salt molybdenum complexes TP-302 and TP-415 (all products of Hodogaya Chemical Co., Ltd.); LRA-901; a boron complex LR-147 (product of Japan Carlit Co., Ltd.); a copper phthalocyanine; perylene; quinacridone; an azo-pigment; and polymeric compounds having, as a functional group, a sulfonic acid group, carboxyl group, quaternary ammonium salt, etc.

The content of the charge controlling agent is not particularly limited and may be appropriately selected depending on the intended purpose, but it is preferably 0.1 to 10 parts by mass, more preferably 0.2 to 5 parts by mass, relative to 100 parts by mass of the toner. When the amount thereof is greater than 10 parts by mass, the charging ability of the toner becomes excessive, which may reduce the effect of the charge controlling agent, increase electrostatic force to a developing roller, leading to low flowability of the developer, or low image density of the resulting image. These charge controlling agents may be dissolved and dispersed after being melted and kneaded together with the master batch, and/or resin. The charge controlling agents can be, of course, directly added to an organic solvent when dissolution and dispersion is performed. Alternatively, the charge controlling agents may be fixed on surfaces of toner particles after the production of the toner particles.

### -External Additive-

Specific examples of the external additives include, but are not limited to, hydrophobized silica, titania, titanium oxide and alumina fine particles. The hydrophobized fine particles can be obtained by subjecting hydrophilic fine particles to surface treatment with silane coupling agents such as methyltrimethoxy silane, methyltriethoxy silane and octyltrimethoxy silane.

Specific examples of the hydrophobized silica fine particles include R972, R974, RX200, RY200, R202, R805, and R812 from Nippon Aerosil Co., Ltd., etc.

Specific examples of the hydrophobized titania fine particles include P-25 from Nippon Aerosil Co., Ltd.; STT-30, and STT-65C-S from Fuji Titanium Industry Co., Ltd.; TAF-140 from Fuji Titanium Industry Co., Ltd.; and MT-150W, MT-500B, MT-600B and MT-150A from Tayca Corporation, etc.

The content of the external additive is not particularly limited and may be appropriately selected depending on the intended purpose, but it is preferably 0.1 to 5 parts by mas, more preferably 0.3 to 3 parts by mass, relative to 100 parts by mass of the toner.

### -Cleanability Improver-

The cleanability improver is not particularly limited and may be appropriately selected depending on the intended purpose so long as it can be added to the toner for the purpose of removing the developer remaining on a photoconductor or a primary transfer member after transferring. Examples thereof include: fatty acid metal salt such as zinc stearate, calcium stearate, and stearic acid; and polymer particles produced by soap-free emulsion polymerization, such as polymethyl methacrylate particles, and polystyrene particles. The polymer particles are preferably those having a relatively narrow particle size distribution, and the polymer particles having the volume average particle diameter of 0.01 μm to 1 μm are preferably used.

### <Methods of Calculating and Analyzing Properties of Toner and Toner Constituents>

The Tg, acid value, hydroxyl value, molecular weight and melting point of each of the amorphous polyester resin, crystalline polyester resin and release agent may be measured from each of the constituents. The toner may be subjected to gel permeation chromatography (GPC) to separate each component to calculate a SP value, a Tg, a molecular weight, a melting point and a mass ratio thereof.

The weight-average molecular weights of the toner and the resin were measured by a GPC measurer GPC-150C from Waters Corp. KF801 to 807 from Shodex is used as a column and an RI (refraction index) detector is used as the detector.

First, 1 g of a toner is added to 100 mL THF, and the resulting mixture is stirred for 30 min at 25° C., to thereby obtain a solution in which soluble components are dissolved.

The solution is then filtered through a membrane filter having an opening of 0.2 to thereby obtain THF soluble matter in the toner.

Next, the THF soluble matter are dissolved in THF, to thereby prepare a sample for measurement of GPC, and the prepared sample is supplied to GPC used for molecular weight measurement of each resin mentioned above.

Separation of each component by GPC can be performed, for example, by the following method.

In GPC measurement using THF (tetrahydrofuran) as a mobile phase, an eluate is subjected to fractionation by a fraction collector, a fraction corresponding to a part of a desired molecular weight is collected from a total area of an elution curve.

The combined eluate is concentrated and dried by an evaporator or the like, and a resulting solid content is dissolved in a deuterated solvent, such as deuterated chloroform, and deuterated THF, followed by measurement of ¹H-NMR. From an integral ratio of each element, a ratio of a constituent monomer of the resin in the elution composition is calculated.

As another method, after concentrating the eluate, hydrolysis is performed with sodium hydroxide or the like, and a ratio of a constituent monomer is calculated by subjecting the decomposed product to a qualitative and quantitative analysis by high performance liquid chromatography (HPLC).

Note that, in the case where the toner is produced by generating the amorphous polyester resin through a chain-elongation reaction and/or crosslink reaction of the non-linear reactive precursor and the curing agent to thereby produce toner base particles, the polyester resin may be separated from an actual toner by GPC or the like, to thereby determine a Tg thereof. Alternatively, the toner may be produced by synthesizing the amorphous polyester resin A through a chain-elongation reaction and/or crosslink reaction of the non-linear reactive precursor and the curing agent, to thereby measure a Tg thereof from the synthesized amorphous polyester resin.

### <<Means for Separating Toner Constituents>>

One example of a separation unit for each component during an analysis of the toner will be specifically explained hereinafter.

First, 1 g of a toner is added to 100 mL THF, and the resulting mixture is stirred for 30 min at 25° C., to thereby obtain a solution in which soluble components are dissolved.

The solution is then filtered through a membrane filter having an opening of 0.2 μm to thereby obtain THF soluble matter in the toner.

Next, the THF soluble matter are dissolved in THF, to thereby prepare a sample for measurement of GPC, and the prepared sample is supplied to GPC used for molecular weight measurement of each resin mentioned above.

Meanwhile, a fraction collector is disposed at an eluate outlet of GPC, to fraction the eluate per a certain count. The eluate is obtained per 5% in terms of the area ratio from the elution onset on the elution curve (raise of the curve).

Next, each eluted fraction, as a sample, in an amount of 30 mg is dissolved in 1 mL of deuterated chloroform, and to this solution, 0.05% by volume of tetramethyl silane (TMS) is added as a standard material. A glass tube for NMR having a diameter of 5 mm is charged with the solution, from which a spectrum is obtained by a nuclear magnetic resonance apparatus (JNM-AL 400, product of JEOL Ltd.) by performing multiplication 128 times at temperature of from 23° C. to 25° C.

The monomer compositions and the compositional ratios of the amorphous polyester resin, the amorphous polyester resin and the crystalline polyester resin in the toner are determined from peak integral ratios of the obtained spectrum.

For example, peaks are grouped as follows, and a component ratio of constitutional monomers is determined from an integrated ratio of each of the group.

Near 8.25 ppm: from a benzene ring of trimellitic acid (one hydrogen atom)

Near 8.07 ppm to 8.10 ppm: from a benzene ring of terephthalic acid (4 hydrogen atoms)

Near 7.1 ppm to 7.25 ppm: from a benzene ring of bisphenol A (4 hydrogen atoms)

Near 6.8 ppm: from a benzene ring of bisphenol A (4 hydrogen atoms) and a double bond of fumaric acid (2 hydrogen atoms)

Near 5.2 ppm to 5.4 ppm: from methylene of an adduct of bisphenol A with propylene oxide (one hydrogen atom)

Near 3.7 ppm to 4.7 ppm: from methylene of an adduct of bisphenol A with propylene oxide (2 hydrogen atoms) and methylene of an adduct of bisphenol A with ethylene oxide (4 hydrogen atoms)

Near 1.6 ppm: from a methyl group of bisphenol A (6 hydrogen atoms) From these results, for example, an abstract collected in a fraction occupied by the amorphous polyester resin by not less than 90% can be regarded as the amorphous polyester resin. Similarly, an abstract collected in a fraction occupied by the crystalline polyester resin by not less than 90% can be regarded as the crystalline polyester resin.

### <<Methods of Measuring Melting Point and Glass Transition Temperature (Tg)>>

In the present invention, a melting point and a glass transition temperature (Tg) of the toner can be measured, for example, by a differential scanning calorimeter (DSC) system (Q-200, product of TA Instruments Japan Inc.).

Specifically, a melting point and a glass transition temperature of samples can be measured in the following manners.

Specifically, first, an aluminum sample container charged with about 5.0 mg of a sample is placed on a holder unit, and the holder unit is then set in an electric furnace. Next, the sample is heated (first heating) from −80° C. to 150° C. at the heating rate of 10° C./min in a nitrogen atmosphere. Then, the sample is cooled from 150° C. to −80° C. at the cooling rate of 10° C./min, followed by again heating (second heating) to 150° C. at the heating rate of 10° C./min. DSC curves are respectively measured for the first heating and the second heating by a differential scanning calorimeter (Q-200, product of TA Instruments Japan Inc.).

The DSC curve for the first heating is selected from the obtained DSC curve by an analysis program stored in the Q-200 system, to thereby determine a glass transition temperature of the sample with the first heating (Tg1st). Similarly, the DSC curve for the second heating is selected, and the glass transition temperature of the sample with the second heating (Tg2nd) can be determined.

When the Tg1st is less than 20° C., the toner may be deteriorated in heat resistant preservability, and blocking within a developing unit and filming on a photoconductor may be caused. When the Tg1st is greater than 50° C., low-temperature fixability of the toner may be deteriorated. When the Tg2nd is less than 0° C., the fixed image (printed matter) may deteriorate in anti-blocking within a developing unit. When greater than 30° C., the toner may not have sufficient low-temperature fixability and glossiness.

Moreover, the DSC curve for the first heating is selected from the obtained DSC curve by the analysis program stored in the Q-200 system, and an endothermic peak top temperature of the sample for the first heating is determined as a melting point of the sample. Similarly, the DSC curve for the second heating is selected, and the endothermic peak top temperature of the sample for the second heating can be determined as a melting point of the sample with the second heating.

Moreover, in the present invention, regarding the glass transition temperature and the melting point of the amorphous polyester resin, the crystalline polyester resin and the other constituent components such as the release agent, the endothermic peak top temperature and the Tg in second heating are defined as the melting point and the Tg of each of the target samples, respectively, unless otherwise specified.

### <Volume-Average Particle Diameter>

The volume-average particle diameter of the toner is not particularly limited and may be appropriately selected depending on the intended purpose, but it is preferably 3 μm to 7 μm. Moreover, a ratio of the volume average particle diameter to the number average particle diameter is preferably not greater than 1.2. Further, the toner preferably contains toner particles having the volume average particle diameter of 2 μm or less, in an amount of 1% by number to 10% by number.

### <Toner Production Method>

A method for producing the toner is not particularly limited and may be appropriately selected depending on the intended purpose such as polymerization methods and pulverization methods. The base toner is preferably granulated by dispersing an oil phase in an aqueous medium, where the oil phase contains the amorphous polyester resin and the crystalline polyester resin, and further contains the release agent and the colorant if necessary.

Moreover, the toner is more preferably granulated by dispersing an oil phase in an aqueous medium, where the oil phase contains a polyester resin which is a prepolymer including a urethane bond and a urea bond as the amorphous polyester resin, the crystalline polyester resin, and further contains the curing agent, the release agent, and the colorant if necessary.

One example of such methods for producing the toner base particle is a known dissolution suspension method. As one example of the methods for producing the toner base particle, a method for forming toner base particles while forming the amorphous polyester resin through elongating reaction and/or cross-linking reaction between the prepolymer and the curing agent will be described hereinafter. This method includes preparing an aqueous medium, preparing an oil phase containing toner materials, emulsifying or dispersing the toner materials, and removing an organic solvent.

### -Preparation of Aqueous Medium-

The preparation of the aqueous phase can be carried out, for example, by dispersing resin particles in an aqueous medium. An amount of the resin particles added to the aqueous medium is not particularly limited and may be appropriately selected depending on the intended purpose, but it is preferably 0.5 to 10 parts by mass relative to 100 parts by weight of the aqueous medium.

The aqueous medium is not particularly limited and may be appropriately selected depending on the intended purpose. Examples thereof include water, a solvent miscible with water, and a mixture thereof. These may be used alone or in combination of two or more thereof. Among them, water is preferable.

The solvent miscible with water is not particularly limited and may be appropriately selected depending on the intended purpose. Examples thereof include alcohol, dimethyl formamide, tetrahydrofuran, cellosolve, and lower ketone. The alcohol is not particularly limited and may be appropriately selected depending on the intended purpose. Examples thereof include methanol, isopropanol, and ethylene glycol. The lower ketone is not particularly limited and may be appropriately selected depending on the intended purpose. Examples thereof include acetone and methyl ethyl ketone.

### -Preparation of Oil Phase-

Preparation of the oil phase containing the toner materials can be performed by dissolving or dispersing toner materials in an organic solvent, where the toner materials contain at least the non-linear reactive precursor, the amorphous polyester resin and the crystalline polyester resin, and further contain the curing agent, the release agent, the colorant, if necessary.

The organic solvent is not particularly limited and may be appropriately selected depending on the intended purpose, but it is preferably an organic solvent having a boiling point of less than 150° C., as removal thereof is easy.

The organic solvent having the boiling point of less than 150° C. is not particularly limited and may be appropriately selected depending on the intended purpose. Examples thereof include toluene, xylene, benzene, carbon tetrachloride, methylene chloride, 1,2-dichloroethane, 1,1,2-trichloroethane, trichloroethylene, chloroform, monochlorobenzene, dichloroethylidene, methyl acetate, ethyl acetate, methyl ethyl ketone, and methyl isobutyl ketone. These may be used alone or in combination.

Among them, ethyl acetate, toluene, xylene, benzene, methylene chloride, 1,2-dichloroethane, chloroform, and carbon tetrachloride are particularly preferable, and ethyl acetate is more preferably used.

### -Preparation of Fine Dispersion of Salicylic Acid Derivative Salt-

Methods of finely dispersing a salicylic acid derivative compound in a toner include a mechanical method finely dispersing the salicylic acid derivative compound by a beads mill or high-pressure homogenizer, etc. in an oil phase, and in an aqueous phase in an emulsion aggregation method. The salicylic acid derivative compound is preferably dispersed to have a particle diameter not greater than 1 μm, and more preferably not greater than 0.5 μm.

Methods of preparing fine crystals or particles in an oil phase or an aqueous phase include a method synthesizing the salicylic acid derivative compound in an oil phase. For example, an aqueous solution of an alkyl-substituted salicylic acid derivative and an aqueous solution of metal salt are put in an oil phase and a salt or a complex forming reaction is performed to prepare a fine zirconium compound in a toner oil phase. Water or a polar solvent such as alcohol and ether may be put in the oil phase to smoothly proceed the reaction.

### -Emulsification or Dispersion-

The emulsification or dispersion of the toner materials can be carried out by dispersing the oil phase containing the toner materials in the aqueous medium. In the course of the emulsification or dispersion of the toner materials, the curing agent and the prepolymer can perform a chain-elongation reaction and/or crosslinking reaction.

The reaction conditions (reaction time and temperature) to form the prepolymer are particularly limited and may be appropriately selected depending on a combination of the curing agent and the prepolymer.

The reaction time is not particularly limited and may be appropriately selected depending on the intended purpose, but it is preferably from 10 min to 40 hrs, more preferably from 2 to 24 hrs.

The reaction temperature is not particularly limited and may be appropriately selected depending on the intended purpose, but it is preferably 0° C. to 150° C., more preferably 30° C. to 50° C.

A method for stably forming the dispersion in the aqueous medium is not particularly limited and may be appropriately selected depending on the intended purpose. Examples thereof include a method for dispersing an oil phase, which is added to an aqueous medium, with shear force, where the oil phase is prepared by dissolving or dispersing toner materials in a solvent.

A disperser used for the dispersing is not particularly limited and may be appropriately selected depending on the intended purpose. Examples thereof include a low-speed shearing disperser, a high-speed shearing disperser, a friction disperser, a high-pressure jetting disperser and an ultrasonic wave disperser.

Among them, the high-speed shearing disperser is preferable, because it can control the particle diameters of the dispersed elements (oil droplets) to the range of 2 to 20 μm.

In the case where the high-speed shearing disperser is used, the conditions for dispersing, such as the rotating speed, dispersion time, and dispersion temperature, may be appropriately selected depending on the intended purpose.

The rotational speed is not particularly limited and may be appropriately selected depending on the intended purpose, but it is preferably 1,000 rpm to 30,000 rpm, more preferably 5,000 rpm to 20,000 rpm.

The dispersion time is not particularly limited and may be appropriately selected depending on the intended purpose, but it is preferably 0.1 to 5 min in case of a batch system.

The dispersion temperature is not particularly limited and may be appropriately selected depending on the intended purpose, but it is preferably 0° C. to 150° C., more preferably 30° C. to 45° C. under pressure. Note that, generally speaking, dispersion can be easily carried out, as the dispersion temperature is higher.

An amount of the aqueous medium used for the emulsification or dispersion of the toner material is not particularly limited and may be appropriately selected depending on the intended purpose, but it is preferably 50 to 2,000 parts by mass, more preferably 100 to 1,000 parts by mass, relative to 100 parts by mass of the toner material.

When the amount of the aqueous medium is less than 50 parts by mass, the dispersion state of the toner material is impaired, which may result a failure in attaining toner base particles having desired particle diameters. When the amount thereof is more than 2,000 parts by mass, the production cost may increase.

When the oil phase containing the toner material is emulsified or dispersed, a dispersant is preferably used for the purpose of stabilizing dispersed elements, such as oil droplets, and gives a sharp particle size distribution as well as giving desirable shapes of toner particles.

The dispersant is not particularly limited and may be appropriately selected depending on the intended purpose. Examples thereof include a surfactant, a water-insoluble inorganic compound dispersant, and a polymer protective colloid. These may be used alone or in combination. Among them, the surfactant is preferably used.

The surfactant is not particularly limited and may be appropriately selected depending on the intended purpose. Examples thereof include an anionic surfactant, a cationic surfactant, a nonionic surfactant, and an amphoteric surfactant.

The anionic surfactant is not particularly limited and may be appropriately selected depending on the intended purpose. Examples thereof include alkyl benzene sulfonic acid salts, α-olefin sulfonic acid salts and phosphoric acid esters. Among them, those having a fluoroalkyl group are preferably used.

### -Removal of Organic Solvent-

A method for removing the organic solvent from the dispersion liquid such as the emulsified slurry is not particularly limited and may be appropriately selected depending on the intended purpose. Examples thereof include: a method in which an entire reaction system is gradually heated to evaporate out the organic solvent in the oil droplets; and a method in which the dispersion liquid is sprayed in a dry atmosphere to remove the organic solvent in the oil droplets.

As the organic solvent removed, toner base particles are formed. The toner base particles can be subjected to washing and drying, and can be further subjected to classification. The classification may be carried out in a liquid by removing small particles by cyclone, a decanter, or centrifugal separator, or may be performed on particles after drying.

The obtained toner base particles is mixed with the external additive. At this time, by applying a mechanical impact during mixing, the external additive can be prevented from fall off from surfaces of toner base particles.

The mechanical impact may be applied by any method without particular limitation and may be properly selected according to purposes. Examples thereof include a method that includes applying an impact to a mixture with a high-speed rotating blade and a method that includes introducing a mixture into a high-speed gas stream and accelerating the gas stream to allow the particles to collide against one another or the particles to collide against a proper collision plate.

A device used for this method is appropriately selected depending on the intended purpose without any limitation, and examples thereof include ANGMILL (product of Hosokawa Micron Corporation), an apparatus produced by modifying I-type mill (product of Nippon Pneumatic Mfg. Co., Ltd.) to reduce the pulverizing air pressure, a hybridization system (product of Nara Machinery Co., Ltd.), a kryptron system (product of Kawasaki Heavy Industries, Ltd.) and an automatic mortar.

### (Developer)

A developer of the present invention contains at least the toner, and may further contain appropriately selected other components, such as carrier, if necessary.

Accordingly, the developer has excellent transfer properties, and charging ability, and can stably form high quality images. Note that, the developer may be a one-component developer, or a two-component developer, but it is preferably a two-component developer when it is used in a high speed printer corresponding to recent high information processing speed, because the service life thereof can be improved.

In the case where the developer is used as a one-component developer, the diameters of the toner particles do not vary largely even when the toner is supplied and consumed repeatedly, the toner does not cause filming to a developing roller, nor fuse to a layer thickness regulating member such as a blade for thinning a thickness of a layer of the toner, and provides excellent and stable developing ability and image even when it is stirred in the developing device over a long period of time.

In the case where the developer is used as a two-component developer, the diameters of the toner particles in the developer do not vary largely even when the toner is supplied and consumed repeatedly, and the toner can provide excellent and stable developing ability even when the toner is stirred in the developing device over a long period of time.

### <Carrier>

The carrier is appropriately selected depending on the intended purpose without any limitation, but it is preferably a carrier containing a core, and a resin layer covering the core.

### -Core Material-

A material of the core is appropriately selected depending on the intended purpose without any limitation, and examples thereof include a 50 to 90 emu/g manganese-strontium (Mn—Sr) material, and a 50 to 90 emu/g manganese-magnesium (Mn—Mg) material. To secure a sufficient image density, use of a hard magnetic material such as iron powder (100 emulg or more), and magnetite (75 to 120 emu/g) is preferable. Moreover, use of a soft magnetic material such as a 30 to 80 emu/g copper-zinc material is preferable because an impact applied to a photoconductor by the developer born on a bearer in the form of a brush can be reduced, which is an advantageous for improving image quality.

These may be used alone or in combination.

A volume-average particle diameter of the core material is not particularly limited and may be appropriately selected depending on the intended purpose, but it is preferably 10 to 150 μM, more preferably 40 to 100 μm. When the volume average particle diameter thereof is less than 10 μm, the proportion of particles in the distribution of carrier particle diameters increases, causing carrier scattering because of low magnetization per carrier particle. When the volume average particle diameter thereof is more than 150 μm, the specific surface area reduces, which may cause toner scattering, causing reproducibility especially in a solid image portion in a full color printing containing many solid image portions.

In the case where the toner is used for a two-component developer, the toner is used by mixing with the carrier.

### (Image Forming Apparatus and Image Forming Method)

An image forming apparatus of the present invention includes at least an electrostatic latent image bearer, an electrostatic latent image forming unit, and a developing unit, and if necessary, further includes other units.

An image forming method of the present invention includes at least an electrostatic latent image forming step and a developing step, and if necessary, further includes other steps.

### <Electrostatic Latent Image Bearer>

The material, structure and size of the electrostatic latent image bearer are not particularly limited and may be appropriately selected depending on the intended purpose. Examples of the material thereof include inorganic photoconductors such as amorphous silicon and selenium and organic photoconductors such as polysilane and phthalopolymethine. Among them, amorphous silicon is preferable in terms of long lifetime.

### <Electrostatic Latent Image Forming Unit and Electrostatic Latent Image Forming Step>

The electrostatic latent image forming unit is not particularly limited and may be appropriately selected depending on the intended purpose so long as it is a unit to form an electrostatic latent image on the electrostatic latent image bearer. Examples thereof include a unit including at least a charging member to charge a surface of the electrostatic latent image bearer and an exposing member to imagewise expose the surface of the electrostatic latent image bearer to light.

The electrostatic latent image forming step is not particularly limited and may be appropriately selected depending on the intended purpose so long as it is a step of forming an electrostatic latent image on the electrostatic latent image bearer. The electrostatic latent image forming step can be performed using the electrostatic latent image forming unit by, for example, charging a surface of the electrostatic latent image bearer and then imagewise exposing the surface thereof to light.

### <<Charging Member and Charging>>

The charging member is not particularly limited and may be appropriately selected depending on the intended purpose. Examples thereof include contact-type charging devices known per se having, for example, an electrically conductive or semiconductive roller, brush, film and rubber blade; and non-contact-type charging devices utilizing corona discharge such as corotron and scorotron.

The charging can be performed by, for example, applying voltage to the surface of the electrostatic latent image bearer by using the charging member.

The charging member may have any shape like a charging roller as well as a magnetic brush or a fur brush. The shape of the charging member may be suitably selected according to the specification or configuration of the image forming apparatus.

The charging member is not limited to the aforementioned contact-type charging members. However, the contact-type charging members are preferably used because an image forming apparatus in which an amount of ozone generated from the charging members is reduced can be obtained

### <<Irradiation Member and Irradiation>>

The irradiation member is not particularly limited and may be appropriately selected depending on the purpose so long as it attains desired imagewise irradiation on the surface of the electrophotographic latent image bearer charged with the charging member. Examples thereof include various irradiation members such as a copy optical irradiation device, a rod lens array irradiation device, a laser optical irradiation device, and a liquid crystal shutter irradiation device.

A light source used for the irradiation member is not particularly limited and may be appropriately selected depending on the intended purpose. Examples thereof include conventional light-emitting devices such as a fluorescent lamp, a tungsten lamp, a halogen lamp, a mercury lamp, a sodium lamp, a light-emitting diode (LED), a laser diode (LD), and an electroluminescence (EL) device.

Also, various filters may be used for emitting only light having a desired wavelength range. Examples of the filters include a sharp-cut filter, a band-pass filter, an infrared cut filter, a dichroic filter, an interference filter, and a color temperature conversion filter.

The irradiation can be performed by, for example, imagewise irradiating the surface of the electrostatic latent image bearer to light using the irradiation member.

In the present invention, light may be imagewise applied from the backside of the electrostatic latent image bearer.

### <Developing Unit and Developing Step>

The developing unit is not particularly limited and may be appropriately selected depending on the intended purpose so long as it is a developing unit containing a toner for developing the electrostatic latent image formed on the electrostatic latent image bearer to thereby form a visible image.

The developing step is not particularly limited and may be appropriately selected depending on the intended purpose so long as it is a step of developing the electrostatic latent image formed on the electrostatic latent image bearer with a toner, to thereby form a visible image. The developing step can be performed by the developing unit.

The developing unit is preferably a developing device containing: a stirring device for charging the toner with friction generated during stirring; a magnetic field-generating unit fixed inside; and a developer bearing member to bear a developer containing the toner on a surface thereof and to be rotatable.

### <<<Developer>>>

A developer of the present invention contains at least the toner, and may further contain appropriately selected other components, such as carrier, if necessary.

It is preferably a two-component developer when it is used in a high speed printer corresponding to recent high information processing speed, because the service life thereof can be improved.

### <<<Carrier>>>

The carrier is appropriately selected depending on the intended purpose without any limitation, but it is preferably a carrier containing a core, and a resin layer covering the core. A material of the core is appropriately selected depending on the intended purpose without any limitation, and examples thereof include a 50 to 90 emu/g manganese-strontium (Mn—Sr) material, and a 50 to 90 emu/g manganese-magnesium (Mn—Mg) material. To secure a sufficient image density, use of a hard magnetic material such as iron powder (100 emu/g or more), and magnetite (75 to 120 emu/g) is preferable. Moreover, use of a soft magnetic material such as a 30 to 80 emu/g copper-zinc material is preferable because an impact applied to a photoconductor by the developer born on a bearer in the form of a brush can be reduced, which is an advantageous for improving image quality.

A volume-average particle diameter of the core material is not particularly limited and may be appropriately selected depending on the intended purpose, but it is preferably 10 to 150 more preferably 40 to 100 μm. When the volume average particle diameter thereof is less than 10 μm, the proportion of particles in the distribution of carrier particle diameters increases, causing carrier scattering because of low magnetization per carrier particle. When the volume average particle diameter thereof is more than 150 μm, the specific surface area reduces, which may cause toner scattering, causing reproducibility especially in a solid image portion in a full color printing containing many solid image portions.

In the case where the toner is used for a two-component developer, the toner is used by mixing with the carrier. An amount of the carrier in the two-component developer is not particularly limited and may be appropriately selected depending on the intended purpose, but it is preferably 90 to 98 parts by mass, more preferably 93 to 97 parts by mass, relative to 100 parts by mass of the two-component developer.

A developer of the present invention may be suitably used in image formation by various known electrophotographic methods such as a magnetic one-component developing method, a non-magnetic one-component developing method, and a two-component developing method.

In the developing unit, toner particles and carrier particles are stirred and mixed so that the toner particles are charged by friction generated therebetween. The charged toner particles are retained in a napping state on the surface of the rotating magnetic roller to form magnetic brushes. The magnetic roller is disposed proximately to the electrostatic latent image developing member and thus, some of the toner particles forming the magnetic brushes on the magnet roller are transferred onto the surface of the electrostatic latent image developing member by the action of electrically attractive force. As a result, the electrostatic latent image is developed with the toner particles to form a visible toner image on the surface of the electrostatic latent image developing member.

### <Other Units and Other Steps>

Examples of the other units include a transfer unit, a fixing unit, a cleaning unit, a charge-eliminating unit, a recycling unit, and a controlling unit.

Examples of the other step include a transfer step, a fixing step, a cleaning step, a charge-eliminating step, a recycling step, and a controlling step.

### <<Transfer Unit and Transfer Step>>

The transfer unit is not particularly limited and may be appropriately selected depending on the intended purpose so long as it is a unit to transfer the visible image onto a recording medium. Preferably, the transfer unit includes: a primary transfer unit to transfer the visible images to an intermediate transfer member to form a composite transfer image; and a secondary transfer unit to transfer the composite transfer image onto a recording medium.

The transfer step is not particularly limited and may be appropriately selected depending on the intended purpose so long as it is a step of transferring the visible image onto a recording medium. In this step, preferably, the visible images are primarily transferred to an intermediate transfer member, and the thus-transferred visible images are secondarily transferred to the recording medium.

For example, the transfer step can be performed using the transfer unit by charging the photoconductor with a transfer charger to transfer the visible image.

Here, when the image to be secondarily transferred onto the recording medium is a color image of several color toners, a configuration can be employed in which the transfer unit sequentially superposes the color toners on top of another on the intermediate transfer member to form an image on the intermediate transfer member, and the image on the intermediate transfer member is secondarily transferred at one time onto the recording medium by the intermediate transfer unit.

The intermediate transfer member is not particularly limited and may be appropriately selected from known transfer members depending on the intended purpose.

For example, the intermediate transfer member is preferably a transferring belt.

The transfer unit (including the primary- and secondary transfer units) preferably includes at least a transfer device which transfers the visible images from the photoconductor onto the recording medium. Examples of the transfer device include a corona transfer device employing corona discharge, a transfer belt, a transfer roller, a pressing transfer roller and an adhesive transferring device.

The recording medium is not particularly limited and may be appropriately selected depending on the purpose, so long as it can receive a developed, unfixed image. Examples of the recording medium include plain paper and a PET base for OHP, with plain paper being used typically.

### <<Fixing Unit and Fixing Step>>

The fixing unit is not particularly limited and may be appropriately selected depending on the intended purpose as long as it is a unit configured to fix a transferred image which has been transferred on the recording medium, but is preferably known heating-pressurizing members. Examples thereof include a combination of a heat roller and a press roller, and a combination of a heat roller, a press roller and an endless belt.

The fixing step is not particularly limited and may be appropriately selected depending on the intended purpose, as long as it is a step of fixing a visible image which has been transferred on the recording medium. The fixing step may be performed every time when an image of each color toner is transferred onto the recording medium, or at one time (at the same time) on a laminated image of color toners.

The fixing step can be performed by the fixing unit.

The heating-pressurizing member usually performs heating preferably at 80° C. to 200° C.

Notably, in the present invention, known photofixing devices may be used instead of or in addition to the fixing unit depending on the intended purpose.

A surface pressure at the fixing step is not particularly limited and may be appropriately selected depending on the intended purpose, but is preferably 10 to 80 N/cm².

### <<Cleaning Unit and Cleaning Step>>

The cleaning unit is not particularly limited and may be appropriately selected depending on the intended purpose, as long as it can remove the toner remaining on the photoconductor. Examples thereof include a magnetic brush cleaner, an electrostatic brush cleaner, a magnetic roller cleaner, a blade cleaner, a brush cleaner and a web cleaner.

The cleaning step is not particularly limited and may be appropriately selected depending on the intended purpose, as long as it is a step of removing the toner remaining on the photoconductor. It may be performed by the cleaning unit.

### <<Charge-Eliminating Unit and Charge-Eliminating Step>>

The charge-eliminating unit is not particularly limited and may be appropriately selected depending on the intended purpose, as long as it is a unit configured to apply a charge-eliminating bias to the photoconductor to thereby charge-eliminate. Examples thereof include a charge-eliminating lamp.

The charge-eliminating step is not particularly limited and may be appropriately selected depending on the intended purpose, as long as it is a step of applying a charge-eliminating bias to the photoconductor to thereby charge-eliminate. It may be carried out by the charge-eliminating unit.

### <<Recycling Unit and Recycling Step>>

The recycling unit is not particularly limited and may be appropriately selected depending on the intended purpose, as long as it is a unit configured to recycle the toner which has been removed at the cleaning step to the developing device. Example thereof includes a known conveying unit.

The recycling step is not particularly limited and may be appropriately selected depending on the intended purpose, as long as it is a step of recycling the toner which has been removed at the cleaning step to the developing device. The recycling step can be performed by the recycling unit.

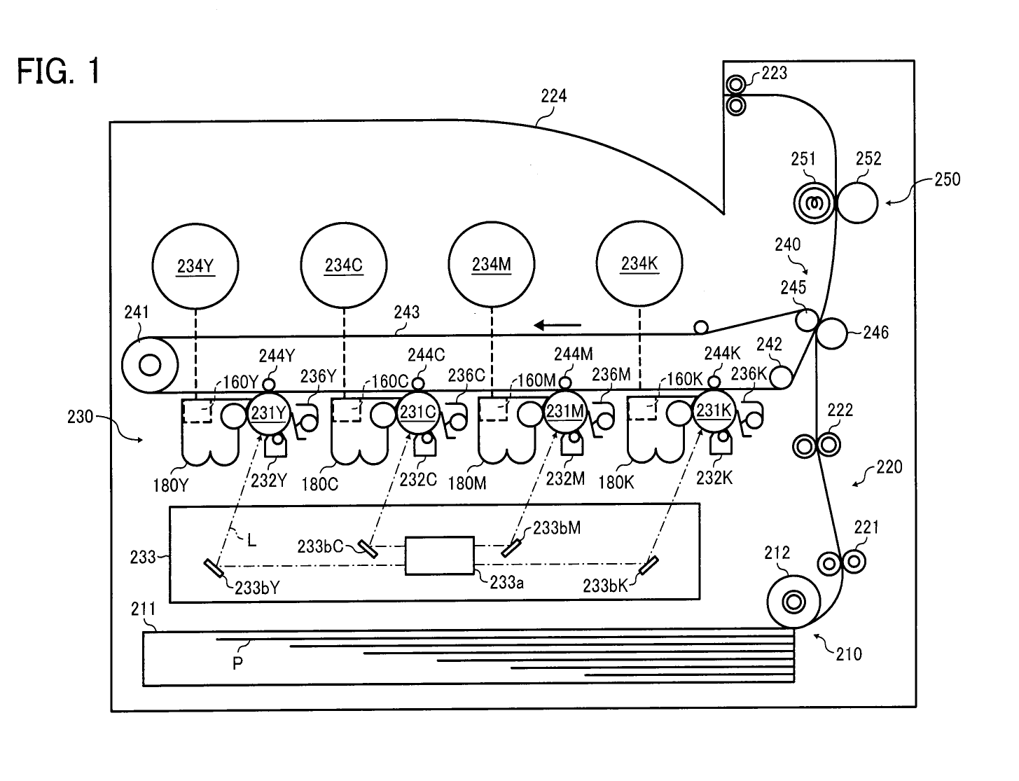

An embodiment of method of forming an image using an image forming apparatus of the present invention will be explained with reference to FIG. 1.

An image forming apparatus 1 is a printer. The image forming apparatus is not particularly limited if it is capable of forming images with a toner, such as copiers, facsimiles and multifunctional machines.

The image forming apparatus 1 includes a paper feeder 210, a conveyor 220, an image former 230, a transferer 240 and a fixer 250.

The paper feeder 210 includes a paper feed cassette 211 papers P to be fed are loaded and a paper feed roller 212 feeding one piece by one of the papers P loaded in the paper feed cassette 211.

The conveyor 220 includes a roller 221 conveying the paper P fed by the paper feed roller 212 in the direction of the transferer 240, a timing roller 222 waiting while pinching an end of the paper P fed by the roller 221 and feeding the paper to the transferer 240 at a predetermined timing, and a paper discharge roller 223 discharging the paper P a color toner image is fixed on onto a paper discharge tray 224.

The image former 230 includes an image forming unit Y using a developer having a yellow toner, an image forming unit C using a developer having a cyan toner, an image forming unit M using a developer having a magenta toner and an image forming unit K using a developer having a black toner in this order from left to right at a predetermined interval in FIG. 1, and an irradiator 233.

An arbitrary image forming unit among the image forming units Y to K is simply referred to as the image forming unit.

The developer includes a toner and a carrier.

The four image forming units Y to K only use developers different from each other and substantially have the same mechanical constitutions.

The transferer 240 includes a drive roller 241, a driven roller 242, an intermediate transfer belt 243 rotatable anticlockwise as the drive roller 241 drives, first transfer rollers 244Y, 244C, 244M and 244K facing a photoconductor drum 231 through the intermediate transfer belt 243, and a second facing roller 245 and a second transfer roller 246 opposite to each other through the intermediate transfer belt 243 at a transfer position where a toner image is transferred to a paper.

The fixer 250 includes a heater inside, and a fixing belt 251 heating a paper P and a pressure roller 252 rotatably pressuring the fixing belt 251 to form a nip, which applies heat and pressure to a toner image on the paper P to be fixed thereon. The paper P the color toner image is fixed on is discharged by the paper discharge roller 223 onto the paper discharge tray 224.

### (Toner Housing Unit)

The toner housing unit in the present invention is a unit capable of housing a toner containing toner. Specific examples thereof include, but are not limited to, toner housing containers, image developers, and process cartridges.

The toner housing container contains a toner.

The image developer contains a toner and has a means of developing.

The process cartridge includes at least an image bearer and an image developer in a body and contains a toner, which is detachable from image forming apparatus. The process cartridge may further include at least one of a charger, an irradiator and a cleaner.

When the toner housing unit is installed in an image forming apparatus, a low-cost toner having good durability, low-temperature fixability, pulverizability, blocking resistance and filming resistance of the present invention forms an image. Therefore, quality images can be produced at low cost.

### <Process Cartridge>

A process cartridge of the present invention is molded so as to be mounted to various image forming apparatuses in an attachable and detachable manner, including at least an electrostatic latent image bearer configured to bear an electrostatic latent image; and a developing unit configured to form a toner image by developing the electrostatic latent image born on the electrostatic latent image bearer with a developer of the present invention. Note that, the process cartridge of the present invention may further include other units, if necessary.

The developing unit includes a developer accommodating container configured to accommodate the developer of the present invention, and a developer bearing member configured to bear and convey the developer accommodated in the developer accommodating container. Note that, the developing unit further includes a regulating member, and the like, in order to regulate a thickness of the developer born.

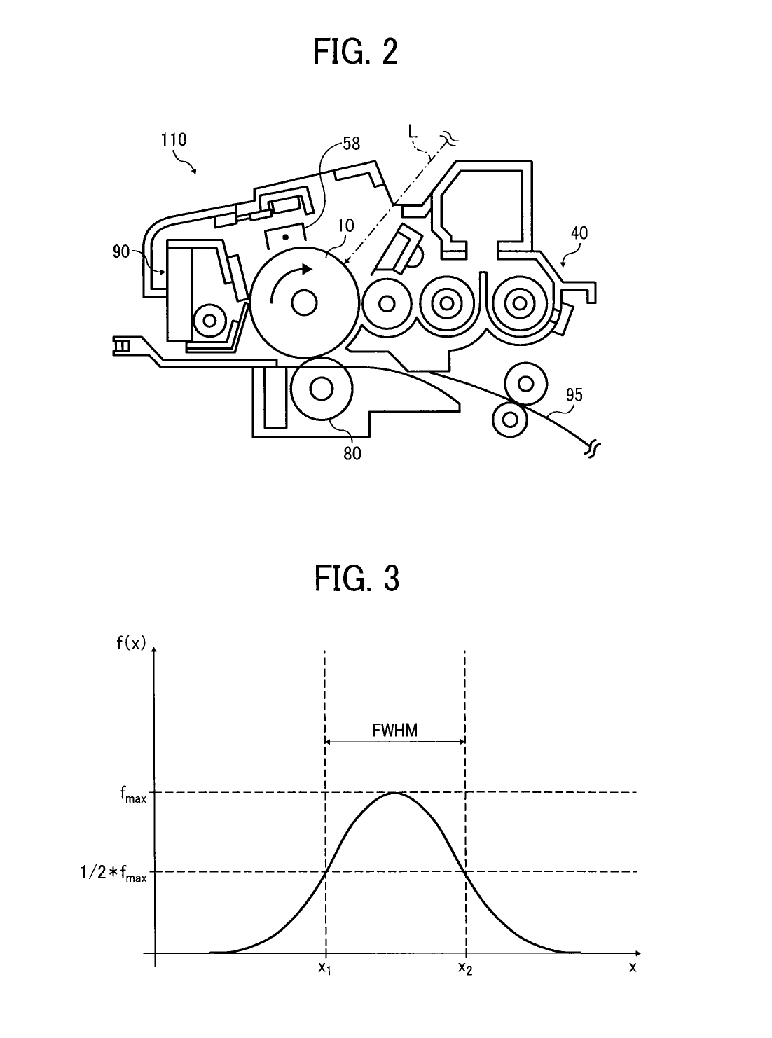

FIG. 2 illustrates one example of a process cartridge of the present invention. A process cartridge 110 includes a photoconductor drum 10, a corona charging device 58, a developing device 40, a transfer roller 80, and a cleaning device 90.

### EXAMPLES

Having generally described this invention, further understanding can be obtained by reference to certain specific examples which are provided herein for the purpose of illustration only and are not intended to be limiting. In the descriptions in the following examples, the numbers represent weight ratios in parts, unless otherwise specified.

### Production Example 1

### Synthesis of Amorphous Polyester Resin A1

A reaction vessel equipped with a condenser, a stirring device, and a nitrogen-introducing tube was charged with 20.3 parts of terephthalic acid, 8.7 parts of isophthalic acid, 40.8 parts of bisphenol A ethylene oxide 2.2 mole adduct, 30.2 parts of bisphenol A propylene oxide 2.2 mole adduct and 0.2 parts of ° oxide. The resultant mixture was reacted at to 230° C. for 4 hours under normal pressure, and further reacted for 5 hours under a reduced pressure of from 10 to 15 mmHg to thereby obtain an [amorphous polyester resin A1].

### Production Example 2

### Synthesis of Amorphous Polyester Resin A2

A reaction vessel equipped with a condenser, a stirring device, and a nitrogen-introducing tube was charged with 25.8 parts of terephthalic acid, 27.8 parts of adipic acid, 44.9 parts of 3-methyl-1,5-pentanediol, 1.5 parts of trimethylolpropane and 0.2 parts of dibutyltinoxide. The resultant mixture was reacted at to 230° C. for 4 hours under normal pressure, and further reacted for 5 hours under a reduced pressure of from 10 to 15 mmHg to thereby obtain an intermediate amorphous polyester resin. Further, 2.0 parts of trimellitic acid was added to the mixture and reacted for 5 hours under a reduced pressure of from 10 to 15 mmHg to thereby obtain an [amorphous polyester resin A2].

### Production Example 3

### Synthesis of Amorphous Polyester Resin A3

A reaction vessel equipped with a condenser, a stirring device, and a nitrogen-introducing tube was charged with 90 parts of the intermediate amorphous polyester resin obtained in production Example 2 and 10 parts of isophorone diisocyanate (IPDI). The resultant mixture was diluted with 100 parts of ethyl acetate and reacted at 80° C. for 5 hrs, to thereby obtain an amorphous polyester resin A3 which is a prepolymer and an ethyl acetate solution including solid contents of 50%.

### Production Example 4

### Synthesis of Crystalline Polyester Resin B

A 5 L four-necked flask equipped with a nitrogen-introducing tube, a dehydration tube, a stirring device, and a thermocouple was charged with dodecanedioic acid ethylene glycol such that molar ratio of hydroxyl group to carboxyl group OH/COOH was 0.9. Moreover, titanium tetraisopropoxide (500 ppm relative to the resin component) was added thereto and the resultant mixture was reacted at 180° C. for 10 hrs, and then heated to 200° C. and reacted for 3 hrs. Further, the mixture was reacted at 8.3 kPa for 2 hrs, to thereby obtain a [crystalline polyester resin B].

Properties of the amorphous polyester resins A1 to A3 and the crystalline polyester resin B are shown in Table 1.

TABLE 1

| | | | | | | Acid value | Hydroxyl |
|---|---|---|---|---|---|---|---|
| | Melting | | | | | (mg | value (mg |
| | point (° C.) | Tg (° C.) | Mw | Mn | Mw/Mn | KOH/g) | KOH/g) |
| Resin A1 | — | 64.3 | 7500 | 2900 | 2.6 | 5.2 | 6.2 |
| Resin A2 | — | −35.8 | 18300 | 5800 | 3.2 | 26.3 | 2.3 |
| Resin A3 | — | −26 | 58000 | 7000 | 8.3 | 0.8 | 0.2 |
| Resin B | 76.6 | — | 28000 | 6100 | 4.6 | 8.3 | 4.4 |

### <Preparation of Masterbatch (MB)>

Water (600), 500 parts of carbon black (NIPEX 60 from Degussa) and 500 parts of the [amorphous polyester resin A1] were added and mixed together by HENSCHEL MIXER (product of NIPPON COKE & ENGINEERING CO., LTD.), and the resultant mixture was kneaded by a two roll mill for 30 min at 150° C. The kneaded product was rolled out and cooled, followed by pulverizing by a pulverizer, to thereby obtain [masterbatch 1].

### <Synthesis of Organic Fine Particle Emulsion (Fine Particle Dispersion)>

A reaction vessel equipped with a stirring bar and a thermometer was charged with 683 parts of water, 11 parts of a sodium salt of sulfuric acid ester of methacrylic acid-ethylene oxide adduct (ELEMINOL RS-30, product of Sanyo Chemical Industries, Ltd.), 138 parts of styrene, 138 parts of methacrylic acid, and 1 part of ammonium persulfate, and the resultant mixture was stirred for 15 min at 400 rpm, to thereby obtain a white emulsion. The obtained emulsion was heated to have the system temperature of 75° C., and then was allowed to react for 5 hrs. To the resultant mixture, 30 parts of a 1% ammonium persulfate aqueous solution was added, followed by aging for 5 hrs at 75° C., to thereby obtain an aqueous dispersion of a vinyl resin (a copolymer of styrene/methacrylic acid/sodium salt of sulfuric acid ester of methacrylic acid ethylene oxide adduct), i.e., a [fine particle dispersion].

The [fine particle dispersion] was measured by LA-920 (product of HORIBA, Ltd.), and as a result, a volume-average particle diameter thereof was found to be 0.14 μm.

### <Preparation of Crystalline Polyester Resin B Dispersion>

A vessel to which a stirring bar and a thermometer had been set was charged with 100 parts of the crystalline polyester resin B and 400 parts of ethyl acetate, followed by heating to 80° C. during stirring. The temperature was maintained at 80° C. for 5 hrs, followed by cooling to 20° C. in 1 hr. The resultant mixture was dispersed by a bead mill (ULTRA VISCOMILL, product of AIMEX CO., Ltd.) under the following conditions: a liquid feed rate of 1 kg/hr, disc circumferential velocity of 6 m/s, zirconia beads having a diameter of 0.5 mm packed to 80% by volume, and 3 passes, to thereby obtain a [crystalline polyester resin B dispersion] including solid contents of 20%.

### <Preparation of WAX Dispersion>

A vessel to which a stirring bar and a thermometer had been set was charged with 100 parts of ester wax WEP-3 having a melting point of 70° C. and an acid value of 0.1 mg KOH/g from NOF Corp. as release agent, and 400 parts of ethyl acetate, followed by heating to 80° C. during stirring. The temperature was maintained at 80° C. for 5 hrs, and then the mixture was cooled to 20° C. in 1 hr. The resultant mixture was dispersed by a bead mill (ULTRA VISCOMILL, product of AIMEX CO., Ltd.) under the following conditions: a liquid feed rate of 1 kg/hr, disc circumferential velocity of 6 m/s, zirconia beads having a diameter of 0.5 mm packed to 80% by volume, and 3 passes, to thereby obtain a [WAX dispersion] including solid contents of 20%.

### <Preparation of Salicylic Acid Derivative Zirconium Salt Dispersion 1>

A vessel to which a stirring bar and a thermometer had been set was charged with 50 parts of 1,3-di-t-zirconiumbutylsalicylate (SZr), 50 parts of the amorphous polyester resin A1 and 400 parts of ethyl acetate, followed by heating to 30° C. during stirring. The temperature was maintained at 30° C. for 1 hr, and then the mixture was cooled to 20° C. in 1 hr. The resultant mixture was dispersed by a bead mill (ULTRA VISCOMILL, product of AIMEX CO., Ltd.) under the following conditions: a liquid feed rate of 1 kg/hr, disc circumferential velocity of 6 m/s, zirconia beads having a diameter of 0.5 mm packed to 80% by volume, and 10 passes, to thereby obtain a [1,3-di-t-zirconiumbutylsalicylate dispersion 1] including solid contents of 20%. The dispersion was measured by LA-920 (product of HORIBA, Ltd.), and as a result, a volume-average particle diameter thereof was found to be 0.25 μm.

### <Preparation of Salicylic Acid Derivative Zirconium Salt Dispersion 2>

The procedure for preparation of the above [1,3-di-t-zirconiumbutylsalicylate dispersion 1] was repeated except for changing 10 passes into 3 passes in the conditions of dispersing the mixture to prepare a [1,3-di-t-zirconiumbutylsalicylate (SZr) dispersion 2] including solid contents of 20%. The dispersion was measured by LA-920 (product of HORIBA, Ltd.), and as a result, a volume-average particle diameter thereof was found to be 1.05 μm.

### (Oil Water Distribution Test)

A screw vial was charged with 30 parts of the SZr dispersion 1 and SZr dispersion 2, and 70 parts of ion-exchanges water, followed by vibrating with a shaker for 1 hr. After the mixture was left for 3 hrs, separation of a clouded phase including 1,3-di-t-zirconiumbutylsalicylate and a transparent phase of water was clearly observed.

Meanwhile, a screw vial was charged with 3 parts of 1,3-di-t-zirconiumbutylsalicylate and 27 parts of ethyl acetate, followed by stirring and mixing for 1 hr. Then, the screw vial was charged with 70 parts of ion-exchanges water, followed by vibrating with a shaker for 1 hr. After the mixture was left for 3 hrs, a clouded water phase including 1,3-di-t-zirconiumbutylsalicylate and a transparent phase of ethyl acetate were observed. This proved 1,3-di-t-zirconiumbutylsalicylate does not release from the SZr dispersion into the water phase.

### <Preparation of Salicylic Acid Derivative Aluminum Salt Dispersion>

The procedure for preparation of the above [1,3-di-t-zirconiumbutylsalicylate dispersion 1] was repeated except for replacing 50 parts of 1,3-di-t-zirconiumbutylsalicylate (SZr) with 50 parts of 1,3-di-t-aluminumbutylsalicylate (SA1) to prepare a [1,3-di-t-aluminumbutylsalicylate dispersion (SA1)] including solid contents of 20%. The dispersion had a volume-average particle diameter of 0.29 μm.

### <Preparation of Salicylic Acid Derivative Iron Salt Dispersion>

The procedure for preparation of the above [1,3-di-t-zirconiumbutylsalicylate dispersion 1] was repeated except for replacing 50 parts of 1,3-di-t-zirconiumbutylsalicylate (SZr) with 50 parts of 1,3-di-t-ironbutylsalicylate (SFe) to prepare a [1,3-di-t-ironbutylsalicylate dispersion (SFe)] including solid contents of 20%. The dispersion had a volume-average particle diameter of 0.23 μm.

### <Preparation of Salicylic Acid Derivative Zinc Salt Dispersion>

The procedure for preparation of the above [1,3-di-t-zirconiumbutylsalicylate dispersion 1] was repeated except for replacing 50 parts of 1,3-di-t-zirconiumbutylsalicylate (SZr) with 50 parts of 1,3-di-t-zincbutylsalicylate (SZn) to prepare a [1,3-di-t-aluminumbutylsalicylate dispersion (SZn)] including solid contents of 20%. The dispersion had a volume-average particle diameter of 0.31 μm.

Each of the SA1 dispersion, SFe dispersion and SZn dispersion was subjected to oil water distribution test to prove the salicylic acid derivative metal salt does not release from the dispersion into the water phase.

### Example 1

### Preparation of Aqueous Phase

Water (312 parts), 11 parts of the [fine particle dispersion], 11 parts of a 48.5% aqueous solution of sodium dodecyl diphenyl ether disulfonate (ELEMINOL MON-7, product of Sanyo Chemical Industries Ltd.), and 28 parts of ethyl acetate were mixed and stirred, to thereby obtain an opaque white liquid. The obtained liquid was used as [aqueous phase].

### <Preparation of Oil Phase>

A vessel was charged with 89 parts of ethyl acetate, 25 parts of the [WAX dispersion liquid], 92 parts of the [amorphous polyester resin A1], 8 parts of the [amorphous polyester resin A2], 16 parts of the [masterbatch 1] and 20 parts of the [SZr dispersion 1], followed by mixing using a TK Homomixer (product of PRIMIX Corp.) at 5,000 rpm for 60 min, to thereby obtain [oil phase].

### <Emulsification—Removal of Solvent>

A container including the [aqueous phase] was charged with the [oil phase], and the resultant mixture was mixed by a TK Homomixer at 13,000 rpm for 3 min, to thereby obtain an [emulsified slurry].

A container equipped with a stirrer and a thermometer was charged with the [emulsified slurry], followed by removing the solvent therein at 30° C. for 8 hrs, to thereby obtain a [dispersion slurry].

### <Washing•Drying>

After subjecting 100 parts of the [dispersion slurry 1] to filtration under a reduced pressure, the obtained cake was subjected twice to a series of treatments (1) to (4) described below, to thereby produce [filtration cake].

(1): ion-exchanged water (100 parts) was added to the filtration cake, followed by mixing with a TK Homomixer (at 12,000 rpm for 10 min), and then the mixture was filtrated;
(2): one hundred (100) parts of 10% aqueous sodium hydroxide solution was added to the filtration cake obtained in (1), followed by mixing with a TK Homomixer (at 12,000 rpm for 30 min), and then the resultant mixture was filtrated under a reduced pressure;
(3): one hundred (100) parts of 10% by weight hydrochloric acid was added to the filtration cake obtained in (2), followed by mixing with a TK Homomixer (at 12,000 rpm for 10 min) and then the mixture was filtrated; and
(4): ion-exchanged water (300 parts) was added to the filtration cake obtained in (3), followed by mixing with a TK Homomixer (at 12,000 rpm for 10 min) and then the mixture was filtrated. The above steps (1) to (4) were repeated twice to prepare a filtration cake. Further, ion-exchanged water was added to the filtration cake to include solid contents of 50%, followed by mixing with a TK Homomixer (at 12,000 rpm for 10 min) to obtain a toner slurry liquid.

Next, the liquid was dried with an air-circulating drier at 45° C. for 48 hrs, and then was caused to pass through a sieve with a mesh size of 75 μm, to thereby obtain [toner base particle H1]. One hundred (100) parts of the [toner base particle H1] were mixed with 1.0 part of NX-90S from Nippon Aerosil Co., Ltd., 1.0 part of JMT-1501B from Tayca Corp. and 1.0 part of the HSP-160A from Fuso Chemical Co., Ltd. by a Henschel mixer, and passed through a sift having a mesh size of 25 μm to thereby obtain a toner of Example 1.

<

### Examples 2 to 13 and Comparative Example 1 to 5

The preparation of the toner in Example 1 was repeated except for changing charge-in quantity according to Table 2 to obtain toners of Examples 2 to 13 and Comparative Example 1 to 5. SZr dispersion was not used in Comparative Example 3 to 5.

### Example 14

### Preparation of Aqueous Phase

Water (312 parts), 11 parts of the [fine particle dispersion], 11 parts of a 48.5% aqueous solution of sodium dodecyl diphenyl ether disulfonate (ELEMINOL MON-7, product of Sanyo Chemical Industries Ltd.), and 28 parts of ethyl acetate were mixed and stirred, to thereby obtain an opaque white liquid. The obtained liquid was used as [aqueous phase].

### <Preparation of Oil Phase>

A vessel was charged with 89 parts of ethyl acetate, 25 parts of the [WAX dispersion liquid], 88 parts of the [amorphous polyester resin A1], 12 parts of the [amorphous polyester resin A2], and 16 parts of the [masterbatch 1], followed by mixing using a TK Homomixer (product of PRIMIX Corp.) at 5,000 rpm for 60 min, to thereby obtain a wax and pigment dispersion in an ethyl acetate resin solution.

(Synthesis of Zirconium Compound in Dispersion)

A solution in which 0.39 parts of zirconium oxychloride (8 hydrates) were dissolved in 5 parts of ion-exchanged water was added to the ethyl acetate dispersion while stirred at 600 rpm by a three-one motor. Meanwhile, 0.61 parts of 1,3-di-t-butylsalicylate were dissolved in 5 parts of 1% of caustic soda. The solution was gradually added to the dispersion for 30 min to synthesize a zirconium compound in an oil phase.

The oil phase was emulsified, de-solvented, washed, dried and mixed with inorganic fine particles in the same manner of Example 1 to obtain a toner of Example 14.

### Example 15

The procedure for preparation of the toner in Example 14 was repeated except for changing Synthesis of Zirconium Compound in Dispersion as follows to obtain a toner of Example 15.

A solution in which 0.78 parts of zirconium oxychloride (8 hydrates) were dissolved in 10 parts of ion-exchanged water was added to the ethyl acetate dispersion while stirred at 600 rpm by a three-one motor. Meanwhile, 1.22 parts of 1,3-di-t-butylsalicylate were dissolved in 10 parts of 1% of caustic soda. The solution was gradually added to the dispersion for 60 min to synthesize a zirconium compound in an oil phase.

### Example 16

The procedure for preparation of the toner in Example 14 was repeated except for changing Synthesis of Zirconium Compound in Dispersion as follows to obtain a toner of Example 16.

A solution in which 1.17 parts of zirconium oxychloride (8 hydrates) were dissolved in 15 parts of ion-exchanged water was added to the ethyl acetate dispersion while stirred at 600 rpm by a three-one motor. Meanwhile, 1.83 parts of 1,3-di-t-butylsalicylate were dissolved in 15 parts of 1% of caustic soda. The solution was gradually added to the dispersion for 90 min to synthesize a zirconium compound in an oil phase.

### Example 17

### Preparation of Oil Phase

A vessel was charged with 49 parts of ethyl acetate, 25 parts of the [WAX dispersion liquid], 78 parts of the [amorphous polyester resin A1], 12 parts of the [amorphous polyester resin A2], 50 parts of the [crystalline polyester resin B dispersion] and 16 parts of the [masterbatch 1], followed by mixing using a TK Homomixer (product of PRIMIX Corp.) at 5,000 rpm for 60 min, to thereby obtain an [oil phase].

### (Synthesis of Zirconium Compound in Dispersion)

A solution in which 0.39 parts of zirconium oxychloride (8 hydrates) were dissolved in 5 parts of ion-exchanged water was added to the ethyl acetate dispersion while stirred at 600 rpm by a three-one motor. Meanwhile, 0.61 parts of 1,3-di-t-butylsalicylate were dissolved in 5 parts of 1% of caustic soda. The solution was gradually added to the dispersion for 30 min to synthesize a zirconium compound in an oil phase.

The oil phase was emulsified, de-solvented, washed, dried and mixed with inorganic fine particles in the same manner of Example 1 to obtain a toner of Example 17.

Storage modulus of the obtained toners when heated and cooled are shown in Table 3.

### Example 18

The procedure for preparation of the toner in Example 2 was repeated except for replacing the [salicylic acid derivative zirconium salt dispersion 1] with the [salicylic acid derivative zirconium salt dispersion 2] to obtain a toner of Example 18.

### Comparative Example 6

The procedure for preparation of the toner in Example 2 was repeated until preparing the [emulsified slurry]. Then, a container equipped with a stirrer and a thermometer was charged with the [emulsified slurry], followed by removing the solvent therein at 80° C. for 2 hrs, to thereby obtain a [dispersion slurry].

### <Washing•Drying>

After subjecting 100 parts of the [dispersion slurry 1] to filtration under a reduced pressure, the obtained cake was subjected twice to a series of treatments (1) to (4) described below, to thereby produce [filtration cake].

(1): ion-exchanged water (100 parts) was added to the filtration cake, followed by mixing with a TK Homomixer (at 12,000 rpm for 10 min), and then the mixture was filtrated;
(2): one hundred (100) parts of 10% aqueous sodium hydroxide solution was added to the filtration cake obtained in (1), followed by mixing with a TK Homomixer (at 12,000 rpm for 30 min), and then the resultant mixture was filtrated under a reduced pressure;
(3): one hundred (100) parts of 10% by weight hydrochloric acid was added to the filtration cake obtained in (2), followed by mixing with a TK Homomixer (at 12,000 rpm for 10 min) and then the mixture was filtrated; and
(4): ion-exchanged water (300 parts) was added to the filtration cake obtained in (3), followed by mixing with a TK Homomixer (at 12,000 rpm for 10 min) and then the mixture was filtrated. The above steps (1) to (4) were repeated twice to prepare a filtration cake. Further, ion-exchanged water was added to the filtration cake to include solid contents of 50%, followed by mixing with a TK Homomixer (at 12,000 rpm for 10 min) to obtain a toner slurry liquid.

Next, the liquid was dried with an air-circulating drier at 45° C. for 48 hrs, and then was caused to pass through a sieve with a mesh size of 75 μm, to thereby obtain [toner base particle H1]. One hundred (100) parts of the [toner base particle H1] were mixed with 1.0 part of NX-90S from Nippon Aerosil Co., Ltd., 1.0 part of JMT-150IB from Tayca Corp. and 1.0 part of the HSP-160A from Fuso Chemical Co., Ltd. by a Henschel mixer, and passed through a sift having a mesh size of 25 μm to thereby obtain a toner of Comparative Example 6.

The toner had a Tg of 52° C. Therefore, the de-solvent process was applied with a temperature of Tg+28° C.

TABLE 2
(1)

| | | Resin A1 | Resin A2 | Resin A3 | Resin B |
|---|---|---|---|---|---|
| | | (part) | (part) | (part) | (part) |
| | Comparative | 96 | 4 | | |
| | Example 1 | | | | |
| Example 1 | | 92 | 8 | | |
| Example 2 | | 88 | 12 | | |
| Example 3 | | 84 | 16 | | |
| | Comparative | 80 | 20 | | |
| | Example 2 | | | | |
| Example 4 | | 88 | | 12(24) | |
| | Comparative | 88 | 12 | | |
| | Example 3 | | | | |
| | Comparative | 84 | 16 | | |
| | Example 4 | | | | |
| | Comparative | 80 | 20 | | |
| | Example 5 | | | | |
| Example 5 | | 88 | 12 | | |
| Example 6 | | 84 | 16 | | |
| Example 7 | | 80 | 20 | | |
| Example 8 | | 88 | 12 | | |
| Example 9 | | 84 | 16 | | |
| Example 10 | | 80 | 20 | | |
| Example 11 | | 88 | 12 | | |
| Example 12 | | 84 | 16 | | |
| Example 13 | | 80 | 20 | | |
| Example 14 | | 88 | 12 | | |
| Example 15 | | 88 | 12 | | |
| Example 16 | | 88 | 12 | | |
| Example 17 | | 78 | 12 | | 10 |
| Example 18 | | 88 | 12 | | |
| | Comparative | 88 | 12 | | |
| | Example 6 | | | | |

(2)

| | | (SZr) | (SA1) | (SFe) | (SZn) |
|---|---|---|---|---|---|
| | | dispersion 1 | dispersion | dispersion | dispersion |
| | | (10 passes) | (10 passes) | (10 passes) | (10 passes) |
| | | (part) | (part) | (part) | (part) |
| | Comparative | 20 | | | |
| | Example 1 | | | | |
| Example 1 | | 20 | | | |
| Example 2 | | 20 | | | |
| Example 3 | | 20 | | | |
| | Comparative | 20 | | | |
| | Example 2 | | | | |
| Example 4 | | 20 | | | |
| | Comparative | 0 | | | |
| | Example 3 | | | | |
| | Comparative | 0 | | | |
| | Example 4 | | | | |
| | Comparative | 0 | | | |
| | Example 5 | | | | |
| Example 5 | | | 20 | | |
| Example 6 | | | 20 | | |
| Example 7 | | | 20 | | |
| Example 8 | | | | 20 | |
| Example 9 | | | | 20 | |
| Example 10 | | | | 20 | |
| Example 11 | | | | | 20 |
| Example 12 | | | | | 20 |
| Example 13 | | | | | 20 |
| Example 14 | | | | | |
| Example 15 | | | | | |
| Example 16 | | | | | |
| Example 17 | | | | | |
| Example 18 | | | | | |
| | Comparative | 2 | | | |
| | Example 6 | | | | |

(3)

| | | (SZr) dispersion | | |
|---|---|---|---|---|
| | | Synthesized in oil | (SZr) dispersion 2 | Heating |
| | | phase (part) | (3 passes) (part) | process |
| | Comparative | | | None |
| | Example 1 | | | |
| Example 1 | | | | None |
| Example 2 | | | | None |
| Example 3 | | | | None |
| | Comparative | | | None |
| | Example 2 | | | |
| Example 4 | | | | None |
| | Comparative | | | None |
| | Example 3 | | | |
| | Comparative | | | None |
| | Example 4 | | | |
| | Comparative | | | None |
| | Example 5 | | | |
| Example 5 | | | | None |
| Example 6 | | | | None |
| Example 7 | | | | None |
| Example 8 | | | | None |
| Example 9 | | | | None |
| Example 10 | | | | None |
| Example 11 | | | | None |
| Example 12 | | | | None |
| Example 13 | | | | None |
| Example 14 | | 10 | | None |
| Example 15 | | 20 | | None |
| Example 16 | | 3 | | None |
| Example 17 | | 2 | | None |
| Example 18 | | | 2 | None |
| | Comparative | | | Yes |
| | Example 6 | | | |

TABLE 3

| | | G′ ↑ 100 (Pa) | G′ ↑ 100 (Pa) |
|---|---|---|---|
| | Comparative Example 1 | 2.1 × 10⁶ | 3.5 × 10⁶ |
| Example 1 | | 8.2 × 10⁵ | 9.3 × 10⁵ |
| Example 2 | | 9.1 × 10⁴ | 2.3 × 10⁵ |
| Example 3 | | 3.8 × 10³ | 1.8 × 10⁴ |
| | Comparative Example 2 | 7.6 × 10² | 2.3 × 10³ |
| Example 4 | | 3.2 × 10⁵ | 4.3 × 10⁵ |
| | Comparative Example 3 | 8.0 × 10⁵ | 7.8 × 10⁵ |
| | Comparative Example 4 | 7.8 × 10⁴ | 6.5 × 10⁴ |
| | Comparative Example 5 | 3.2 × 10³ | 2.5 × 10³ |
| Example 5 | | 8.0 × 10⁵ | 8.9 × 10⁵ |
| Example 6 | | 8.8 × 10⁴ | 1.5 × 10⁵ |
| Example 7 | | 4.4 × 10³ | 1.1 × 10⁴ |
| Example 8 | | 8.5 × 10⁵ | 8.8 × 10⁵ |
| Example 9 | | 6.8 × 10⁴ | 1.1 × 10⁵ |
| Example 10 | | 3.0 × 10³ | 9.5 × 10³ |
| Example 11 | | 6.8 × 10⁵ | 7.5 × 10⁵ |
| Example 12 | | 9.0 × 10⁴ | 9.9 × 10⁴ |
| Example 13 | | 4.0 × 10³ | 5.1 × 10³ |
| Example 14 | | 8.7 × 10⁴ | 2.5 × 10⁵ |
| Example 15 | | 8.9 × 10⁴ | 4.0 × 10⁵ |
| Example 16 | | 9.0 × 10⁴ | 9.5 × 10⁵ |
| Example 17 | | 6.3 × 10⁴ | 1.2 × 10⁵ |
| Example 18 | | 8.8 × 10⁴ | 1.5 × 10⁵ |
| | Comparative Example 6 | 2.4 × 10⁵ | 2.2 × 10⁵ |

The toners of Examples and Comparative Examples were filled in an image forming apparatus to evaluate.

A digital full-color multifunctional printer MP C6003 was used as the apparatus.

### <Evaluation of Fixability>

A solid image having a size of 3 cm×15 cm was produced on a PPC paper 6000<70W>A4 T from Ricoh Company, Ltd. so as to have a toner adhering to the image in an amount of 0.85 mg/cm². The fixing temperature was decreased 1° C. by 1° C. from 160° C. and an image was produced every time to visually observe adherence of the toner to a paper. The temperature at which cold offset started occurring was measured.

### <Evaluation of Blocking Resistance>

Two hundred (200) pieces of a solid image having a size of 3 cm×15 cm were continuously produced on each one side of PPC papers 6000<70W>A4 T from Ricoh Company, Ltd. so as to have a toner adhering to each of the images in an amount of 0.85 mg/cm². The fixing temperature was controlled to be cold offset temperature+20° C. on average. The 200 produced images were left for 1 hr while stacked, and sticking between images was evaluated.

### (Criteria of Blocking Resistance Evaluation)

Excellent: No sticking

Good: Slightly sticking, but the papers were easily separated from each other and the image had no problem in quality

Average: Slightly sticking, and slight noises were made when the papers were separated from each other, but the image had no problem in quality

Fair: Slightly sticking, and the image deteriorated in glossiness when the papers were separated from each other

Poor: The papers stuck to each other, the image and the papers were damaged when

### <Evaluation of Image Preservability>

A solid image having a size of 3 cm×15 cm was produced on one side of a PPC paper 6000<70W>A4 T from Ricoh Company, Ltd. so as to have a toner adhering to the image in an amount of 0.85 mg/cm². The fixing temperature was controlled to be cold offset temperature+20° C. on average. The resultant images were contacted to each other, a weight equivalent to 8 kPa was placed thereon, and left for 1 week under an environment of 60° C. 50% RH. Then, they were peeled off from each other to observe.

### (Criteria of Image Preservability Evaluation)

Excellent: The papers did not stick to each other at all, and there were no missing images and no image transfer

Good: The papers slightly stuck to each other (slight made noises) when peeled off from each other, but they were easily separated from each other without any missing image and image transfer.

Fair: The papers stuck to each other, and there were missing images and image transfer

Poor: The papers stuck to each other, and there were serious missing images and the papers broke

TABLE 4

| | | | Fixing | | | | |
|---|---|---|---|---|---|---|---|
| | | | Temperature | Blocking | R_{M} | R_{AV} | Image |
| | | Fixability | (° C.) | Resistance | (%) | (%) | Preservability |
| | Comparative | Poor | 160 | Good | 5 | 60 | Fair |
| | Example 1 | | | | | | |
| Example 1 | | Fair | 135 | Good | 12 | 55 | Excellent |
| Example 2 | | Good | 125 | Excellent | 30 | 48 | Excellent |
| Example 3 | | Good | 120 | Good | 55 | 35 | Good |
| | Comparative | Excellent | 110 | Poor | 90 | 25 | Fair |
| | Example 2 | | | | | | |
| Example 4 | | Good | 125 | Excellent | 0 | 0 | Excellent |
| | Comparative | Fair | 135 | Poor | 0 | 0 | Poor |
| | Example 3 | | | | | | |
| | Comparative | Good | 120 | Poor | 0 | 0 | Poor |
| | Example 4 | | | | | | |
| | Comparative | Good | 125 | Poor | 0 | 0 | Poor |
| | Example 5 | | | | | | |
| Example 5 | | Fair | 130 | Average | 7 | 42 | Good |
| Example 6 | | Good | 125 | Good | 20 | 30 | Good |
| Example 7 | | Good | 115 | Good | 30 | 21 | Fair |
| Example 8 | | Fair | 125 | Average | 5 | 45 | Excellent |
| Example 9 | | Good | 120 | Good | 12 | 33 | Good |
| Example 10 | | Good | 115 | Good | 23 | 26 | Good |
| Example 11 | | Fair | 125 | Average | 8 | 38 | Excellent |
| Example 12 | | Good | 120 | Fair | 15 | 22 | Good |
| Example 13 | | Good | 115 | Fair | 21 | 15 | Fair |
| Example 14 | | Good | 115 | Good | 30 | 74 | Excellent |
| Example 15 | | Good | 120 | Excellent | 60 | 59 | Excellent |
| Example 16 | | Good | 120 | Excellent | 150 | 85 | Excellent |
| Example 17 | | Excellent | 110 | Excellent | 12 | 63 | Good |
| Example 18 | | Good | 120 | Fair | 5 | 8 | Fair |
| | Comparative | Fair | 160 | Fair | 5 | 7 | Good |
| | Example 6 | | | | | | |

The evaluation results of each of the toners are shown in Table 4 with a rate of change R_{M} of weight-average molecular weight and a rate of change R_{AV} of acid value of each of the toners.

As shown in Table 4, toners having low R_{AV} are difficult to react when fixed and have poor blocking resistance.

The image forming apparatus of the present invention is capable of fixing at low temperature, saving power consumption, and producing images having good blocking resistance and preservability.

Having now fully described the invention, it will be apparent to one of ordinary skill in the art that many changes and modifications can be made thereto without departing from the spirit and scope of the invention as set forth therein.

What is claimed is:

1. A toner fixable on an image bearer with heat,
wherein the toner has a first storage modulus of from 1×10³ to 1×10⁶ Pa, measured at 100° C. when being heated, and a second storage modulus of from 1×10³ to 1×10⁶ Pa, measured at 100° C. when being cooled, the first storage modulus and second storage modulus being measured by a rheometer, and
wherein the second storage modulus at 100° C. when being cooled is higher than the first storage modulus at 100° C. when being heated.

2. The toner of claim 1, wherein the first storage modulus is from 1×10⁴ to 1×10⁵ Pa, measured at 100° C. when being heated, and the second storage modulus is from 1×10⁴ to 1×10⁵ Pa, measured at 100° C. when being cooled.

3. The toner of claim 1, wherein a rate of change R_{M} (%) determined from the following formula (1) is from 10% to 140%:
R_{M}=(Mw2−Mw1)/Mw1×100 (1)
wherein Mw1 represents a weight-average molecular weight of the toner before heated; and
Mw2 represents a weight-average molecular weight of the toner after heated.

4. The toner of claim 3, wherein the rate of change R_{M} (%) is from 30% to 80%.

5. The toner of claim 1, comprising a crystalline polyester resin.

6. The toner of claim 1, comprising a binder resin, wherein the binder resin includes:
a polyester resin having an acid value; and
a member selected from the group consisting of a metal complex or salt of a salicylic acid having the following formula (2) and a metal complex or salt of a hydroxyl naphthoic acid derivative: 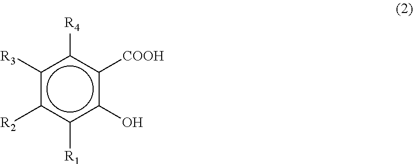
wherein R¹, R², R³ and R⁴ independently represent a member selected from the group consisting of a hydrogen atom, an alkyl group having 1 to 12 carbon atoms, an alkenyl group having 1 to 12 carbon atoms, —OH, —NH₂, —NH(CH₃), —N(CH₃)₂, —OCH₃, —O(C₂H₅), —COOH and —CONH₂; and the metal salt is a member selected from the group consisting of Zn²⁺, Al³⁺, Cr³⁺, Fe³⁺ or Zr⁴⁺.

7. The toner of claim 1, wherein a rate of change R_{AV} (%) determined from the following formula (3) is from 20% to 80%:
R_{AV}=(Av2−Av1)/Av1×100 (3)
wherein Av1 represents an acid value of the toner before heated; and Av2 represents an acid value of thereof after heated.

8. A method of producing the toner according to claim 1, comprising:
dissolving or dispersing at least a binder resin in an organic solvent to prepare a solution or a first dispersion;
dispersing or emulsifying the solution or the dispersion in an aqueous medium to prepare an emulsion or a second dispersion; and
removing the organic solvent from the emulsion or the dispersion.

9. A toner housing unit housing the toner according to claim 1.

10. An image forming apparatus, comprising:
a photoconductor;
a charger to charge the photoconductor;
an irradiator to irradiate the photoconductor to form an electrostatic latent image on the photoconductor;
an image developer to develop the electrostatic latent image with the toner according to claim 1 to form a toner image on the photoconductor;
a transferer to transfer the toner image onto a recording medium; and
a fixer to fix the toner image on the recording medium.

11. An image forming method, comprising:
forming an electrostatic latent image on a photoconductor;
developing the electrostatic latent image with the toner according to claim 1 to form a toner image on the photoconductor;
transferring the toner image onto a recording medium; and
fixing the toner image on the recording medium.
